(19) United States
(12) Patent Application Publication
(10) Pub. No.: US 2026/0253508 A1
(43) Pub. Date: Aug. 27, 2026

(54) SYSTEM AND METHOD FOR CULTURAL SENSITIVITY TRAINING

(71) Applicant: University of South Alabama, Mobile, AL (US)

(72) Inventor: Bhushan Lohar, Mobile, AL (US)

(73) Assignee: University of South Alabama, Mobile, AL (US)

(21) Appl. No.: 19/547,219

(22) Filed: Feb. 23, 2026

Related U.S. Application Data
(60) Provisional application No. 63/763,674, filed on Feb. 26, 2025.

(51) Int. Cl. G09B 9/00; G06F 21/62; G09B 19/00

(52) U.S. Cl. CPC G09B 9/00; G06F 21/6281; G09B 19/00

(57) ABSTRACT

A system and method for virtual patient simulations enhances cultural sensitivity training and clinical decision-making in medical education. The system utilizes machine learning techniques and language models to create realistic, diverse patient scenarios reflecting a wide range of cultural, ethnic, and socioeconomic backgrounds. Simulated patient interactions use algorithms to generate responses based on trainee input and training data. A rapport score system evaluates trainee interactions, considering factors such as empathy, active listening, and cultural sensitivity. The system allows trainees to practice gathering patient information, making diagnoses, and developing treatment plans while navigating cultural differences and language barriers. When integrated into formal training programs, it acts as a mechanism for instructors to review and analyze trainee performance along these metrics. By providing diverse simulated patient interactions, the system may help healthcare professionals improve cultural competency and communication skills, potentially leading to better patient outcomes in real-world clinical settings.

### FIELD OF INVENTION

The subject matter of the present disclosure relates to systems for training, and more particularly to systems simulating virtual interactions.

### BACKGROUND

Virtual patient simulations have become an increasingly important tool in medical education and training. These systems allow healthcare professionals to practice patient interactions, diagnosis, and treatment in a safe, controlled environment. Current virtual patient systems typically present standardized scenarios with pre-programmed responses, allowing trainees to develop basic clinical skills and decision-making abilities. These systems address the need for clinical trainees to apply medical concepts to patient experiences and identify how a patient might describe their symptoms, an invaluable skill for any patient-facing medical professional.

However, existing virtual patient simulations often fall short in representing the diverse backgrounds and cultural nuances encountered in real-world healthcare settings. Many systems present patients with limited demographic variation, failing to adequately prepare healthcare providers for interactions with individuals from different cultural, ethnic, and socioeconomic backgrounds. This lack of diversity in simulated patients can lead to gaps in communication skills and cultural competency among healthcare professionals. Additionally, current virtual patient systems may not fully capture the complexities of patient-provider interactions, particularly when it comes to information gathering and building rapport. Many existing simulations do not provide sufficient opportunities for trainees to practice navigating cultural differences, language barriers, or varying health beliefs and practices.

Furthermore, the feedback mechanisms in current virtual patient systems are often limited, focusing primarily on clinical decision-making rather than on the nuances of patient communication and cultural sensitivity. This can result in healthcare providers who are technically proficient but may struggle with the interpersonal aspects of patient care, particularly when interacting with diverse patient populations. When applied to real patients, this shortcoming can result in reluctance to seek medical treatment, needlessly impeded collection of data relevant to a clinical diagnosis, and poor adherence to a regimen not directly administered by a medical professional. Generally, the generation of an adversarial or pseudo-adversarial relationship between clinicians and patients is a damaging outcome that can be avoided with proper preparation.

There is a growing recognition in the medical field of the need for more comprehensive and culturally sensitive training tools. Improved virtual patient simulations that incorporate a wide range of patient backgrounds and cultural contexts could potentially enhance healthcare providers' ability to collect accurate patient information, build trust, and ultimately improve patient satisfaction and outcomes. The present invention addresses this shortcoming by incorporating language learning models and machine learning techniques in a system for virtual patient simulations. By training medical professionals using this technique, medical institutions will be better prepared to address the needs of patients in a culturally, religiously, and linguistically pluralistic society.

### SUMMARY

A system and method for virtual patient simulations to enhance cultural sensitivity training and clinical decision making in medical education is described. In one aspect, the present invention is a system for medical trainees to practice clinical decision-making in a safe environment. In another aspect, the present invention is a system for training medical professionals to interact with patients of different cultural and socioeconomic backgrounds. In yet another aspect, the present invention is a tool for evaluating cultural competence and clinical skills by instructors in a medical training program. In still another aspect, the present invention is a method for executing instructions using a machine learning technique to train medical professionals in clinical decision-making and cultural sensitivity. Generally, the present invention is a training tool that prepares medical professionals to interact with patients of varying clinical status and cultural background.

The system utilizes machine learning techniques and language models to create realistic, diverse patient scenarios that reflect a wide range of cultural, ethnic, and socioeconomic backgrounds. Broadly speaking, it comprises a computing device with a user interface for trainees to interact with simulated patients, including one or more displays that present the simulated patient avatar, vital signs, and other relevant clinical information. Servers, processors, non-transitory computer-readable media coupled to processors, and databases for storing instructions and data are operably connected with the computing device and ensure appropriate execution of training programs. A multiplicity of permission levels ensures data security and all authorized users any number of accesses to training scenarios, observation of results, and modification of training data. A plurality of computing devices may access the same user or training data through the use of remote access and confirming permission levels.

Simulated patient interactions utilize machine learning algorithms that generate patient responses based on the trainee's input and the simulated patient's training data. The simulated patient's training data includes vital signs, patient complaints, discoverable data, and background information about the simulated patient. Importantly, background information contains data indicating non-clinical information indicating cultural and socioeconomic markers that can influence patient responses. A rapport score system evaluates the trainee's interaction with the simulated patient, considering factors such as empathy, active listening, cultural sensitivity, and communication clarity. The simulated interaction is enhanced with customizable patient avatars and animations that provide visual cues about the patient's condition and demeanor.

The system allows trainees to practice gathering patient information, making diagnoses, and developing treatment plans while navigating cultural differences and language barriers. When integrated into formal training programs for medical professionals, it further acts as a mechanism for instructors to review and analyze trainee performance, including changes to rapport scores and clinical decision-making records. By providing a diverse range of simulated patient interactions, the system may help healthcare professionals improve their cultural competency and communication skills, potentially leading to better patient outcomes in real-world clinical settings.

The foregoing summary has outlined some features of systems and methods used to determine when mitochondrial transfer has occurred so that those skilled in the pertinent art may better understand the detailed description that follows. Additional features that form the subject of the claims will be described hereinafter. Those skilled in the pertinent art should appreciate that they can readily utilize these features for preparing and testing other biological samples such as plasma, serum, or mucosal swabs. Those skilled in the pertinent art should also realize that such equivalent designs or modifications do not depart from the scope of the method of the present disclosure.

### BRIEF DESCRIPTION OF FIGURES

These and other features, aspects, and advantages of the present disclosure will become better understood with regard to the following description, appended claims, and accompanying drawings where:

FIG. 1 illustrates a system embodying features consistent with the principles of the present disclosure.

FIG. 2 illustrates a system embodying features consistent with the principles of the present disclosure.

FIG. 3 illustrates an environment embodying features consistent with the principles of the present disclosure.

FIG. 4 illustrates a system embodying features consistent with the principles of the present disclosure.

FIG. 5 illustrates a sample computing device with a user interface displaying data consistent with the principles of the present disclosure.

FIG. 6 illustrates a simulated patient interaction consistent with the principles of the present disclosure.

FIG. 7 illustrates an array of training data for generating a simulated patient interaction consistent with the principles of the present disclosure.

FIG. 8 illustrates the manner in which individual access to data may be granted or limited based on user roles and administrator roles.

FIG. 9 illustrates scenarios that may be chosen within the user interface consistent with the principles of the present disclosure.

FIG. 10 illustrates scenarios that may be chosen within the user interface consistent with the principles of the present disclosure.

FIG. 11 illustrates scenarios that may be chosen within the user interface consistent with the principles of the present disclosure.

FIG. 12 illustrates how a user may choose a difficulty level of a scenario via a user interface consistent with the principles of the present disclosure.

FIG. 13 illustrates a dashboard of a user profile presented via a user interface consistent with the principles of the present disclosure.

FIG. 14 illustrates a dashboard of a user profile presented via a user interface consistent with the principles of the present disclosure.

FIG. 15 illustrates a medical professional scenario presented via a user interface consistent with the principles of the present disclosure.

FIG. 16 illustrates a law enforcement scenario presented via a user interface consistent with the principles of the present disclosure.

FIG. 17 illustrates a law enforcement scenario presented via a user interface consistent with the principles of the present disclosure.

FIG. 18 illustrates an emergency dispatcher scenario presented via a user interface consistent with the principles of the present disclosure.

FIG. 19 illustrates an interview scenario presented via a user interface consistent with the principles of the present disclosure.

FIG. 20 illustrates how the system creates scenario models consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For instance, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises”, and grammatical equivalents thereof are used herein to mean that other components, steps, etc. are optionally present. For instance, a system “comprising” components A, B, and C can contain only components A, B, and C, or can contain not only components A, B, and C, but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). As will be evident from the disclosure provided below, the present invention satisfies the need for a system and method for training medical professionals in clinical decision-making and cultural sensitivity.

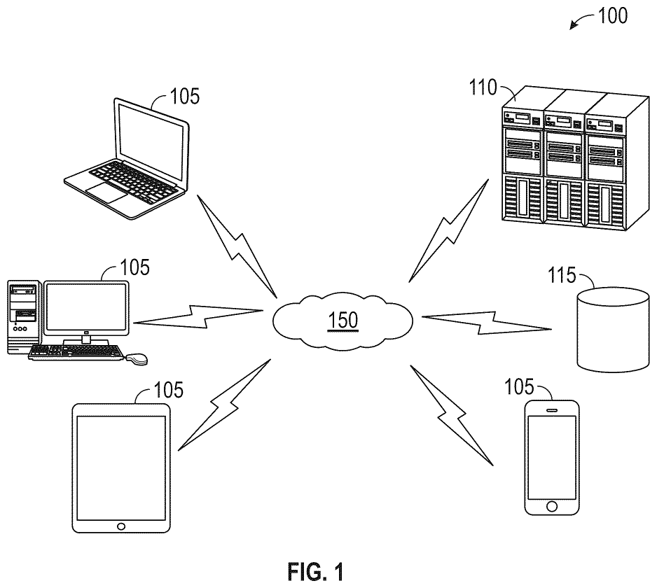

FIG. 1 depicts an exemplary environment 100 of the system 400 consisting of clients 105 connected to a server 110 and/or database 115 via a network 150. Clients 105 are devices of users 405 that may be used to access servers 110 and/or databases 115 through a network 150. A network 150 may comprise of one or more networks of any kind, including, but not limited to, a local area network (LAN), a wide area network (WAN), metropolitan area networks (MAN), a telephone network, such as the Public Switched Telephone Network (PSTN), an intranet, the Internet, a memory device, another type of network, or a combination of networks. In a preferred embodiment, computing entities 200 may act as clients 105 for a user 405. For instance, a client 105 may include a personal computer, a wireless telephone, a streaming device, a “smart” television, a personal digital assistant (PDA), a laptop, a smart phone, a tablet computer, or another type of computation or communication interface 280. Servers 110 may include devices that access, fetch, aggregate, process, search, provide, and/or maintain documents. Although FIG. 1 depicts a preferred embodiment of an environment 100 for the system 400, in other implementations, the environment 100 may contain fewer components, different components, differently arranged components, and/or additional components than those depicted in FIG. 1. Alternatively, or additionally, one or more components of the environment 100 may perform one or more other tasks described as being performed by one or more other components of the environment 100.

As depicted in FIG. 1, one embodiment of the system 400 may comprise a server 110. Although shown as a single server 110 in FIG. 1, a server 110 may, in some implementations, be implemented as multiple devices interlinked together via the network 150, wherein the devices may be distributed over a large geographic area and performing different functions or similar functions. For instance, two or more servers 110 may be implemented to work as a single server 110 performing the same tasks. Alternatively, one server 110 may perform the functions of multiple servers 110. For instance, a single server 110 may perform the tasks of a web server and an indexing server 110. Additionally, it is understood that multiple servers 110 may be used to operably connect the processor 220 to the database 115 and/or other content repositories. The processor 220 may be operably connected to the server 110 via wired or wireless connection. Types of servers 110 that may be used by the system 400 include, but are not limited to, search servers, document indexing servers, and web servers, or any combination thereof.

Search servers may include one or more computing entities 200 designed to implement a search engine, such as a documents/records search engine, general webpage search engine, etc. Search servers may, for instance, include one or more web servers designed to receive search queries and/or inputs from users 405, search one or more databases 115 in response to the search queries and/or inputs, and provide documents or information, relevant to the search queries and/or inputs, to users 405. In some implementations, search servers may include a web search server that may provide webpages to users 405, wherein a provided webpage may include a reference to a web server at which the desired information and/or links are located. The references to the web server at which the desired information is located may be included in a frame and/or text box, or as a link to the desired information/document. Document indexing servers may include one or more devices designed to index documents available through networks 150. Document indexing servers may access other servers 110, such as web servers that host content, to index the content. In some implementations, document indexing servers may index documents/records stored by other servers 110 connected to the network 150. Document indexing servers may, for instance, store and index content, information, and documents relating to user accounts and user-generated content. Web servers may include servers 110 that provide webpages to clients 105. For instance, the webpages may be HTML-based webpages. A web server may host one or more websites. As used herein, a website may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

As used herein, a database 115 refers to a set of related data and the way it is organized. Access to this data is usually provided by a database management system (DBMS) consisting of an integrated set of computer software that allows users 405 to interact with one or more databases 115 and provides access to all of the data contained in the database 115. The DBMS provides various functions that allow entry, storage and retrieval of large quantities of information and provides ways to manage how that information is organized. Because of the close relationship between the database 115 and the DBMS, as used herein, the term database 115 refers to both a database 115 and DBMS.

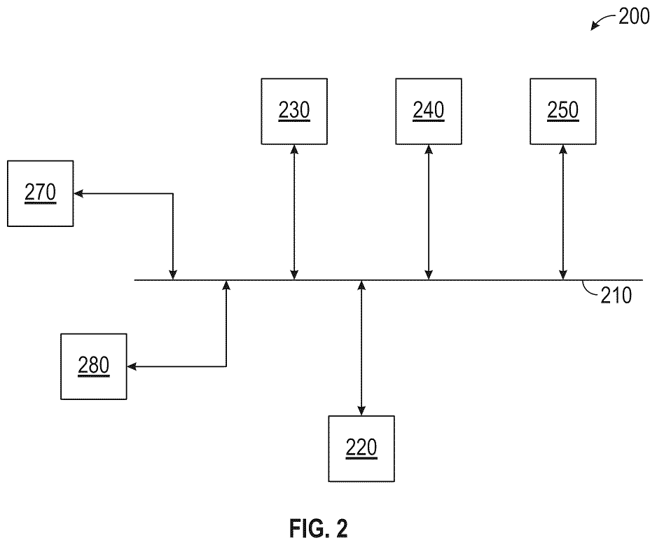

FIG. 2 is an exemplary diagram of a client 105, server 110, and/or or database 115 (hereinafter collectively referred to as “computing entity 200”), which may correspond to one or more of the clients 105, servers 110, and databases 115 according to an implementation consistent with the principles of the invention as described herein. The computing entity 200 may comprise a bus 210, a processor 220, memory 304, a storage device 250, a peripheral device 270, and a communication interface 280 (such as wired or wireless communication device). The bus 210 may be defined as one or more conductors that permit communication among the components of the computing entity 200. The processor 220 may be defined as logic circuitry that responds to and processes the basic instructions that drive the computing entity 200. Memory 304 may be defined as the integrated circuitry that stores information for immediate use in a computing entity 200. A peripheral device 270 may be defined as any hardware used by a user 405 and/or the computing entity 200 to facilitate communicate between the two. A storage device 250 may be defined as a device used to provide mass storage to a computing entity 200. A communication interface 280 may be defined as any transceiver-like device that enables the computing entity 200 to communicate with other devices and/or computing entities 200.

The bus 210 may comprise a high-speed interface 308 and/or a low-speed interface 312 that connects the various components together in a way such they may communicate with one another. A high-speed interface 308 manages bandwidth-intensive operations for computing device 300, while a low-speed interface 312 manages lower bandwidth-intensive operations. In some preferred embodiments, the high-speed interface 308 of a bus 210 may be coupled to the memory 304, display 316, and to high-speed expansion ports 310, which may accept various expansion cards such as a graphics processing unit (GPU). In other preferred embodiments, the low-speed interface 312 of a bus 210 may be coupled to a storage device 250 and low-speed expansion ports 314. The low-speed expansion ports 314 may include various communication ports, such as USB, Bluetooth, Ethernet, wireless Ethernet, etc. Additionally, the low-speed expansion ports 314 may be coupled to one or more peripheral devices 270, such as a keyboard, pointing device, scanner, and/or a networking device, wherein the low-speed expansion ports 314 facilitate the transfer of input data from the peripheral devices 270 to the processor 220 via the low-speed interface 312.

The processor 220 may comprise any type of conventional processor or microprocessor that interprets and executes computer readable instructions. The processor 220 is configured to perform the operations disclosed herein based on instructions stored within the system 400. The processor 220 may process instructions for execution within the computing entity 200, including instructions stored in memory 304 or on a storage device 250, to display graphical information for a graphical user interface (GUI) on an external peripheral device 270, such as a display 316. The processor 220 may provide for coordination of the other components of a computing entity 200, such as control of user interfaces 411, 511, 711, applications run by a computing entity 200, and wireless communication by a communication interface 280 of the computing entity 200. The processor 220 may be any processor or microprocessor suitable for executing instructions. In some embodiments, the processor 220 may have a memory device therein or coupled thereto suitable for storing the data, content, or other information or material disclosed herein. In some instances, the processor 220 may be a component of a larger computing entity 200. A computing entity 200 that may house the processor 220 therein may include, but are not limited to, laptops, desktops, workstations, personal digital assistants, servers 110, mainframes, cellular telephones, tablet computers, smart televisions, streaming devices, or any other similar device. Accordingly, the inventive subject matter disclosed herein, in full or in part, may be implemented or utilized in devices including, but are not limited to, laptops, desktops, workstations, personal digital assistants, servers 110, mainframes, cellular telephones, tablet computers, smart televisions, streaming devices, or any other similar device.

Memory 304 stores information within the computing device 300. In some preferred embodiments, memory 304 may include one or more volatile memory units. In another preferred embodiment, memory 304 may include one or more non-volatile memory units. Memory 304 may also include another form of computer-readable medium, such as a magnetic, solid state, or optical disk. For instance, a portion of a magnetic hard drive may be partitioned as a dynamic scratch space to allow for temporary storage of information that may be used by the processor 220 when faster types of memory, such as random-access memory (RAM), are in high demand. A computer-readable medium may refer to a non-transitory computer-readable memory device. A memory device may refer to storage space within a single storage device 250 or spread across multiple storage devices 250. The memory 304 may comprise main memory 230 and/or read only memory (ROM) 240. In a preferred embodiment, the main memory 230 may comprise RAM or another type of dynamic storage device 250 that stores information and instructions for execution by the processor 220. ROM 240 may comprise a conventional ROM device or another type of static storage device 250 that stores static information and instructions for use by processor 220. The storage device 250 may comprise a magnetic and/or optical recording medium and its corresponding drive.

As mentioned earlier, a peripheral device 270 is a device that facilitates communication between a user 405 and the processor 220. The peripheral device 270 may include, but is not limited to, an input device and/or an output device. As used herein, an input device may be defined as a device that allows a user 405 to input data and instructions that is then converted into a pattern of electrical signals in binary code that are comprehensible to a computing entity 200. An input device of the peripheral device 270 may include one or more conventional devices that permit a user 405 to input information into the computing entity 200, such as a controller, scanner, phone, camera, scanning device, keyboard, a mouse, a pen, voice recognition and/or biometric mechanisms, etc. As used herein, an output device may be defined as a device that translates the electronic signals received from a computing entity 200 into a form intelligible to the user 405. An output device of the peripheral device 270 may include one or more conventional devices that output information to a user 405, including a display 316, a printer, a speaker, an alarm, a projector, etc. Additionally, storage devices 250, such as CD-ROM drives, USB drives, and other computing entities 200 may act as a peripheral device 270 that may act independently from the operably connected computing entity 200. For instance, a streaming device may transfer data to a smartphone, wherein the smartphone may use that data in a manner separate from the streaming device.

The storage device 250 is capable of providing the computing entity 200 mass storage. In some embodiments, the storage device 250 may comprise a computer-readable medium such as the memory 304, storage device 250, or memory 304 on the processor 220. A computer-readable medium may be defined as one or more physical or logical memory devices and/or carrier waves. Devices that may act as a computer readable medium include, but are not limited to, a hard disk device, optical disk device, tape device, flash memory or other similar solid-state memory device, or an array of devices, including devices in a storage area network or other configurations. Examples of computer-readable mediums include, but are not limited to, magnetic media such as hard disks, floppy disks, and magnetic tape; optical media such as CD ROM discs and DVDs; magneto-optical media such as optical discs; and hardware devices that are specially configured to store and perform programming instructions, such as ROM 240, RAM, flash memory, and the like.

In an embodiment, a computer program may be tangibly embodied in the storage device 250. The computer program may contain instructions that, when executed by the processor 220, performs one or more steps that comprise a method, such as those methods described herein. The instructions within a computer program may be carried to the processor 220 via the bus 210. Alternatively, the computer program may be carried to a computer-readable medium, wherein the information may then be accessed from the computer-readable medium by the processor 220 via the bus 210 as needed. In a preferred embodiment, the software instructions may be read into memory 304 from another computer-readable medium, such as data storage device 250, or from another device via the communication interface 280. Alternatively, hardwired circuitry may be used in place of or in combination with software instructions to implement processes consistent with the principles as described herein. Thus, implementations consistent with the invention as described herein are not limited to any specific combination of hardware circuitry and software.

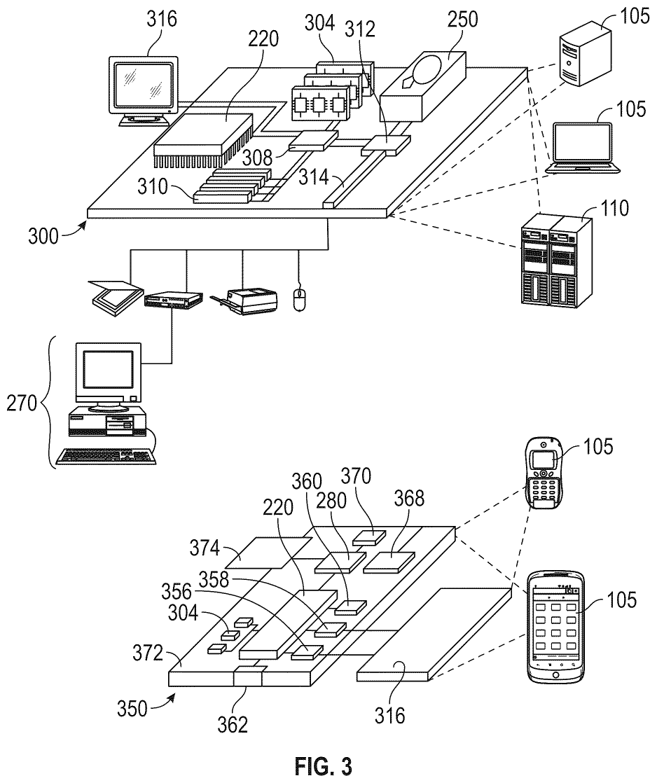

FIG. 3 depicts exemplary computing entities 200 in the form of a computing device 300 and mobile computing device 350, which may be used to carry out the various embodiments of the invention as described herein. A computing device 300 is intended to represent various forms of digital computers, such as laptops, desktops, workstations, servers 110, databases 115, mainframes, and other appropriate computers. A mobile computing device 350 is intended to represent various forms of mobile devices, such as scanners, scanning devices, personal digital assistants, cellular telephones, smart phones, tablet computers, and other similar devices. The various components depicted in FIG. 3, as well as their connections, relationships, and functions are meant to be examples only, and are not meant to limit the implementations of the invention as described herein. The computing device 300 may be implemented in a number of different forms, as shown in FIGS. 1 and 3. For instance, a computing device 300 may be implemented as a server 110 or in a group of servers 110. Computing devices 300 may also be implemented as part of a rack server system. In addition, a computing device 300 may be implemented as a personal computer, such as a desktop computer or laptop computer. Alternatively, components from a computing device 300 may be combined with other components in a mobile device, thus creating a mobile computing device 350. Each mobile computing device 350 may contain one or more computing devices 300 and mobile devices, and an entire system may be made up of multiple computing devices 300 and mobile devices communicating with each other as depicted by the mobile computing device 350 in FIG. 3. The computing entities 200 consistent with the principles of the invention as disclosed herein may perform certain receiving, communicating, generating, output providing, correlating, and storing operations as needed to perform the various methods as described in greater detail below.

In the embodiment depicted in FIG. 3, a computing device 300 may include a processor 220, memory 304 a storage device 250, high-speed expansion ports 310, low-speed expansion ports 314, and bus 210 operably connecting the processor 220, memory 304, storage device 250, high-speed expansion ports 310, and low-speed expansion ports 314. In one preferred embodiment, the bus 210 may comprise a high-speed interface 308 connecting the processor 220 to the memory 304 and high-speed expansion ports 310 as well as a low-speed interface 312 connecting to the low-speed expansion ports 314 and the storage device 250. Because each of the components are interconnected using the bus 210, they may be mounted on a common motherboard as depicted in FIG. 3 or in other manners as appropriate. The processor 220 may process instructions for execution within the computing device 300, including instructions stored in memory 304 or on the storage device 250. Processing these instructions may cause the computing device 300 to display graphical information for a GUI on an output device, such as a display 316 coupled to the high-speed interface 308. In other implementations, multiple processors and/or multiple buses may be used, as appropriate, along with multiple memory units and/or multiple types of memory. Additionally, multiple computing devices may be connected, wherein each device provides portions of the necessary operations.

A mobile computing device 350 may include a processor 220, memory 304 a peripheral device 270 (such as a display 316, a communication interface 280, and a transceiver 368, among other components). A mobile computing device 350 may also be provided with a storage device 250, such as a micro-drive or other previously mentioned storage device 250, to provide additional storage. Preferably, each of the components of the mobile computing device 350 are interconnected using a bus 210, which may allow several of the components of the mobile computing device 350 to be mounted on a common motherboard as depicted in FIG. 3 or in other manners as appropriate. In some implementations, a computer program may be tangibly embodied in an information carrier. The computer program may contain instructions that, when executed by the processor 220, perform one or more methods, such as those described herein. The information carrier is preferably a computer-readable medium, such as memory, expansion memory 374, or memory 304 on the processor 220 such as ROM 240, that may be received via the transceiver or external interface 362. The mobile computing device 350 may be implemented in a number of different forms, as shown in FIG. 3. For instance, a mobile computing device 350 may be implemented as a cellular telephone, part of a smart phone, personal digital assistant, or other similar mobile device.

The processor 220 may execute instructions within the mobile computing device 350, including instructions stored in the memory 304 and/or storage device 250. The processor 220 may be implemented as a chipset of chips that may include separate and multiple analog and/or digital processors. The processor 220 may provide for coordination of the other components of the mobile computing device 350, such as control of the user interfaces 411, applications run by the mobile computing device 350, and wireless communication by the mobile computing device 350. The processor 220 of the mobile computing device 350 may communicate with a user 405 through the control interface 358 coupled to a peripheral device 270 and the display interface 356 coupled to a display 316. The display 316 of the mobile computing device 350 may include, but is not limited to, Liquid Crystal Display (LCD), Light Emitting Diode (LED) display, Organic Light Emitting Diode (OLED) display, and Plasma Display Panel (PDP), holographic displays, augmented reality displays, virtual reality displays, or any combination thereof. The display interface 356 may include appropriate circuitry for causing the display 316 to present graphical and other information to a user 405. The control interface 358 may receive commands from a user 405 via a peripheral device 270 and convert the commands into a computer readable signal for the processor 220. In addition, an external interface 362 may be provided in communication with processor 220, which may enable near area communication of the mobile computing device 350 with other devices. The external interface 362 may provide for wired communications in some implementations or wireless communication in other implementations. In a preferred embodiment, multiple interfaces may be used in a single mobile computing device 350 as is depicted in FIG. 3.

Memory 304 stores information within the mobile computing device 350. Devices that may act as memory 304 for the mobile computing device 350 include, but are not limited to computer-readable media, volatile memory, and non-volatile memory. Expansion memory 374 may also be provided and connected to the mobile computing device 350 through an expansion interface 372, which may include a Single In-Line Memory Module (SIM) card interface or micro secure digital (Micro-SD) card interface. Expansion memory 374 may include, but is not limited to, various types of flash memory and non-volatile random-access memory (NVRAM). Such expansion memory 374 may provide extra storage space for the mobile computing device 350. In addition, expansion memory 374 may store computer programs or other information that may be used by the mobile computing device 350. For instance, expansion memory 374 may have instructions stored thereon that, when carried out by the processor 220, cause the mobile computing device 350 perform the methods described herein. Further, expansion memory 374 may have secure information stored thereon; therefore, expansion memory 374 may be provided as a security module for a mobile computing device 350, wherein the security module may be programmed with instructions that permit secure use of a mobile computing device 350. In addition, expansion memory 374 having secure applications and secure information stored thereon may allow a user 405 to place identifying information on the expansion memory 374 via the mobile computing device 350 in a non-hackable manner.

A mobile computing device 350 may communicate wirelessly through the communication interface 280, which may include digital signal processing circuitry where necessary. The communication interface 280 may provide for communications under various modes or protocols, including, but not limited to, Global System Mobile Communication (GSM), Short Message Services (SMS), Enterprise Messaging System (EMS), Multimedia Messaging Service (MMS), Code Division Multiple Access (CDMA), Time Division Multiple Access (TDMA), Personal Digital Cellular (PDC), Wideband Code Division Multiple Access (WCDMA), IMT Multi-Carrier (CDMAX 0), and General Packet Radio Service (GPRS), or any combination thereof. Such communication may occur, for example, through a transceiver 368. Short-range communication may occur, such as using a Bluetooth, WIFI, or other such transceiver 368. In addition, a Global Positioning System (GPS) receiver module 370 may provide additional navigation-and location-related wireless data to the mobile computing device 350, which may be used as appropriate by applications running on the mobile computing device 350. Alternatively, the mobile computing device 350 may communicate audibly using an audio codec 360, which may receive spoken information from a user 405 and covert the received spoken information into a digital form that may be processed by the processor 220. The audio codec 360 may likewise generate audible sound for a user 405, such as through a speaker, e.g., in a handset of mobile computing device 350. Such sound may include sound from voice telephone calls, recorded sound such as voice messages, music files, etc. Sound may also include sound generated by applications operating on the mobile computing device 350.

The system 400 may comprise a power supply, which may be any source of power that provides the system 400 with the required energy. In a preferred embodiment, the power supply may be a stationary power source that has been installed in a way such that it is fastened in place, such as a 3-prong wall outlet. In a preferred embodiment, the stationary power source is connected to the wiring system of a premises. In another preferred embodiment, the power supply may be a mobile power source, such as a battery pack. In a preferred embodiment, mobile power source does not need to be connected to the wiring system of a premises to provide power to the system but may be capable of connecting to the wiring system of said premises to provide power to a system connected thereto. In another preferred embodiment, the system 400 may comprise multiple power supplies configured to supply power to the system 400 in different circumstances. For instance, the system 400 may be directly plugged into a stationary power source, which may provide power to the system 400 so long as the system does not move out of range of said stationary power source, as well as connected to a mobile power source, which may provide power to the system 400 when the system 400 is not connected to a stationary power source or in situations where the stationary power source ceases to provide power to the system 400.

The system 400 may comprise a power supply, which may be any source of power that provides the system 400 with the required energy. In a preferred embodiment, the power supply may be a stationary power source that has been installed in a way such that it is fastened in place, such as a 3-prong wall outlet. In a preferred embodiment, the stationary power source is connected to the wiring system of a premises, such as a house or a building. In another preferred embodiment, the power supply may be a mobile power source, such as a battery pack, gas-powered generator, and fuel cell. In a preferred embodiment, the mobile power source does not need to be connected to the wiring system of a premises to provide power to the system but may be capable of connecting to the wiring system of said premises to provide power to a system connected thereto. In another preferred embodiment, the system 400 may comprise multiple power supplies configured to supply power to the system 400 in different circumstances. For instance, the system 400 may be directly plugged into a stationary power source, which may provide power to the system 400 so long as the system does not move out of range of said stationary power source, as well as connected to a mobile power source, which may provide power to the system 400 when the system 400 is not connected to a stationary power source or in situations where the stationary power source ceases to provide power to the system 400. In yet another preferred embodiment, a plurality of solar charging panels may be operably connected to a battery of the system, which may then supply power to the system either directly or via the wiring of the premises. As such, the system 400 may be configured to receive power in a variety of ways without departing from the inventive subject matter described herein.

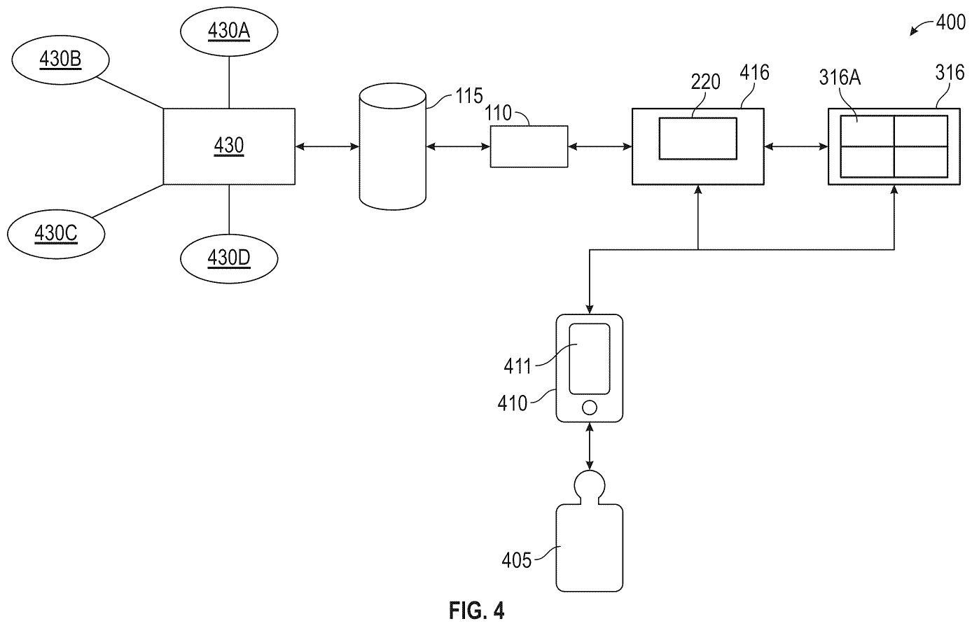

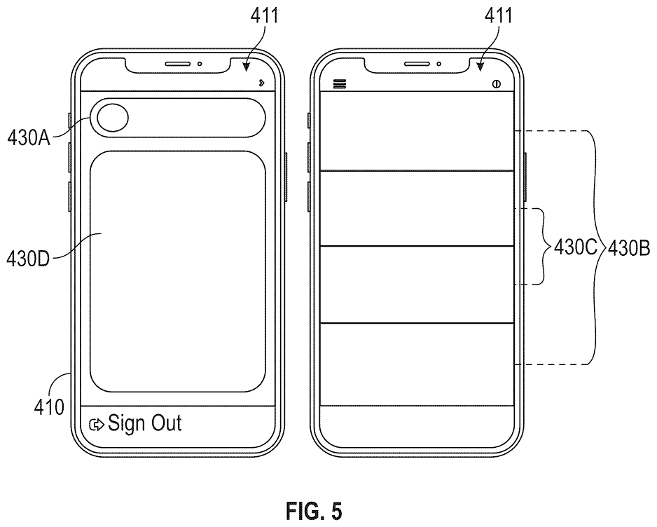

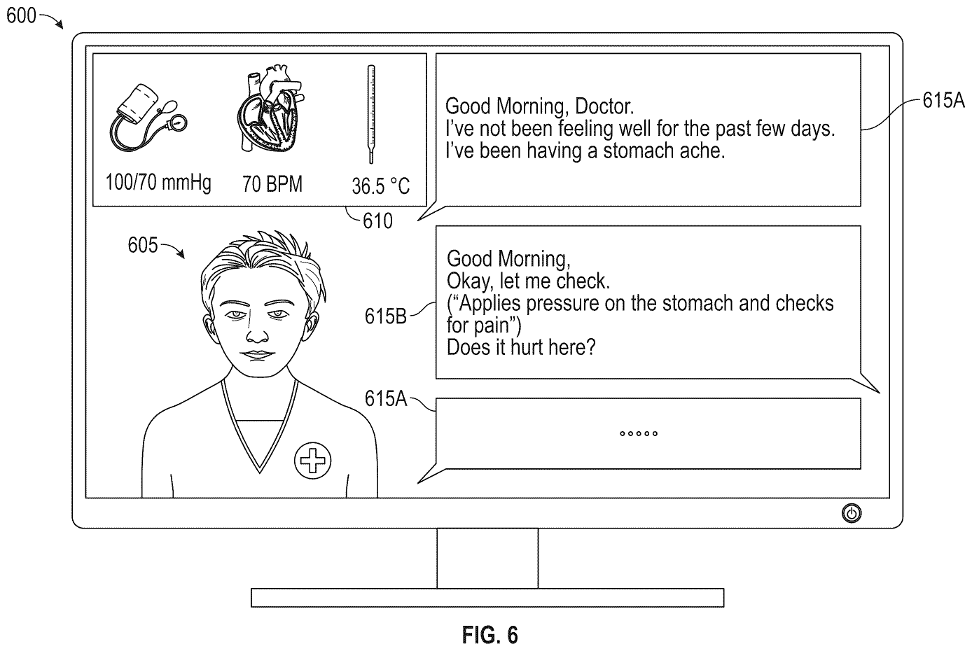

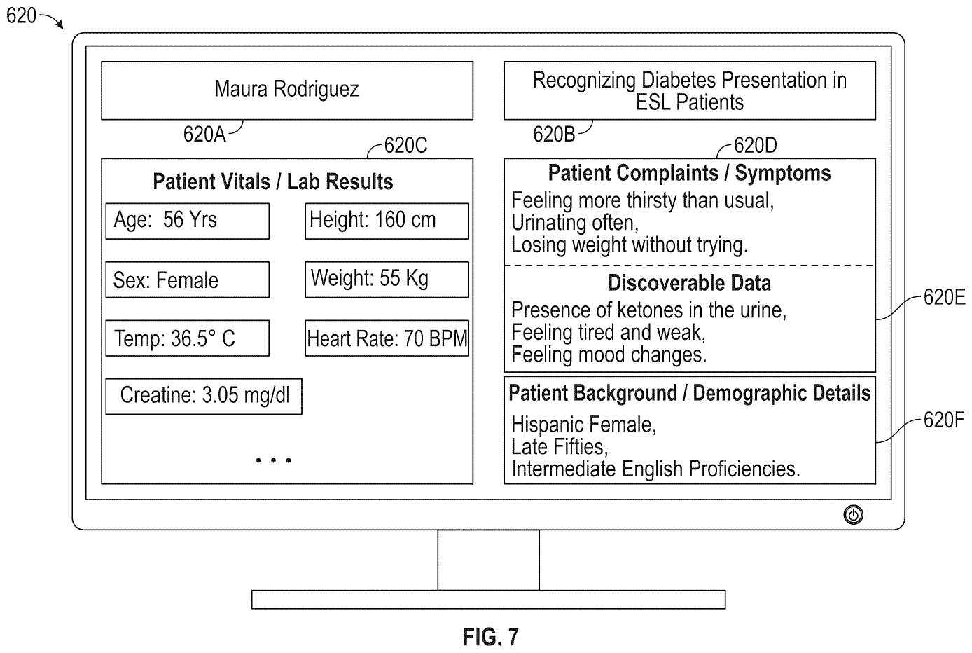

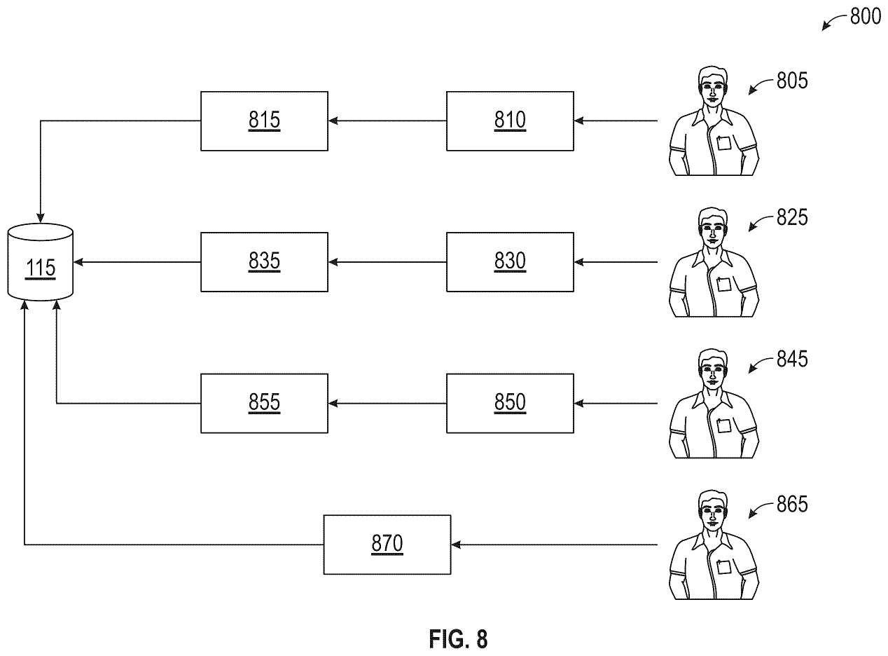

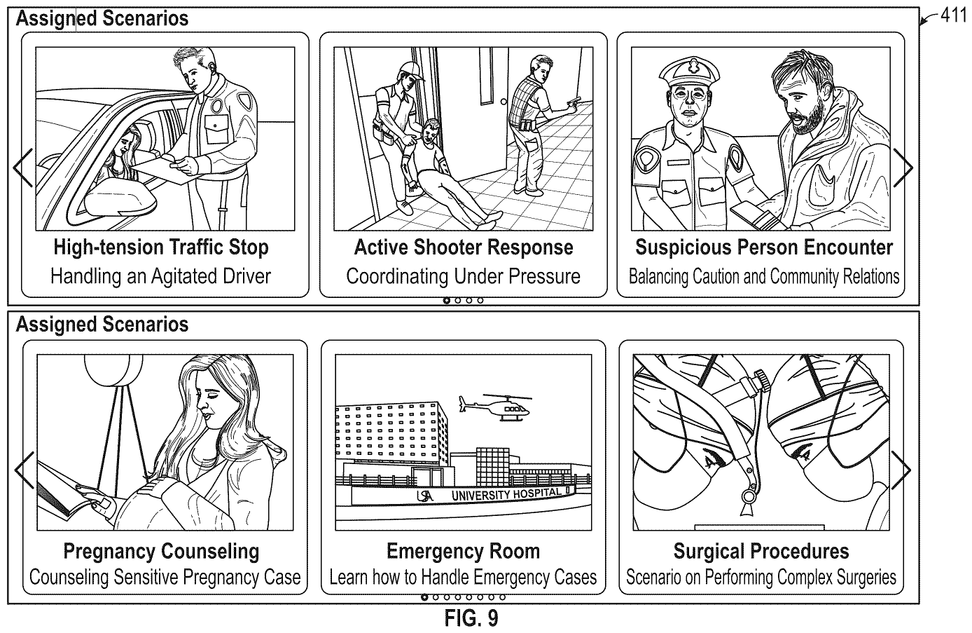

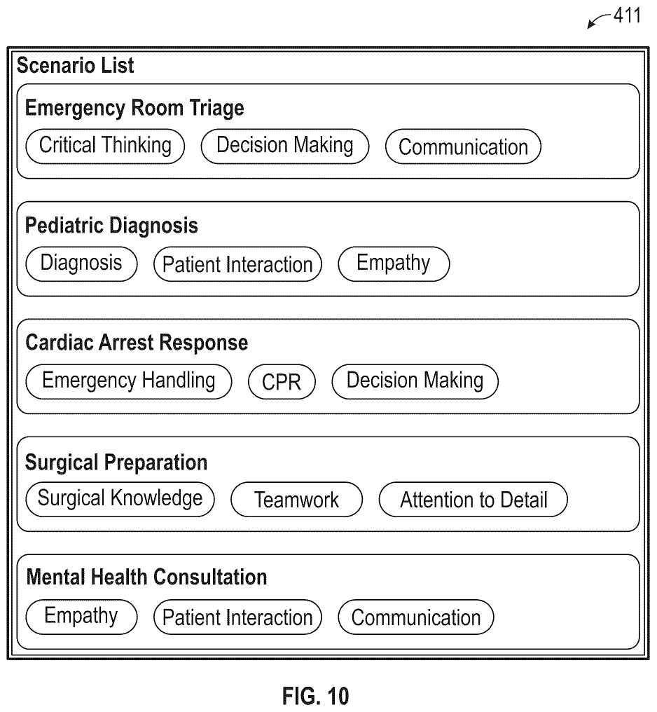

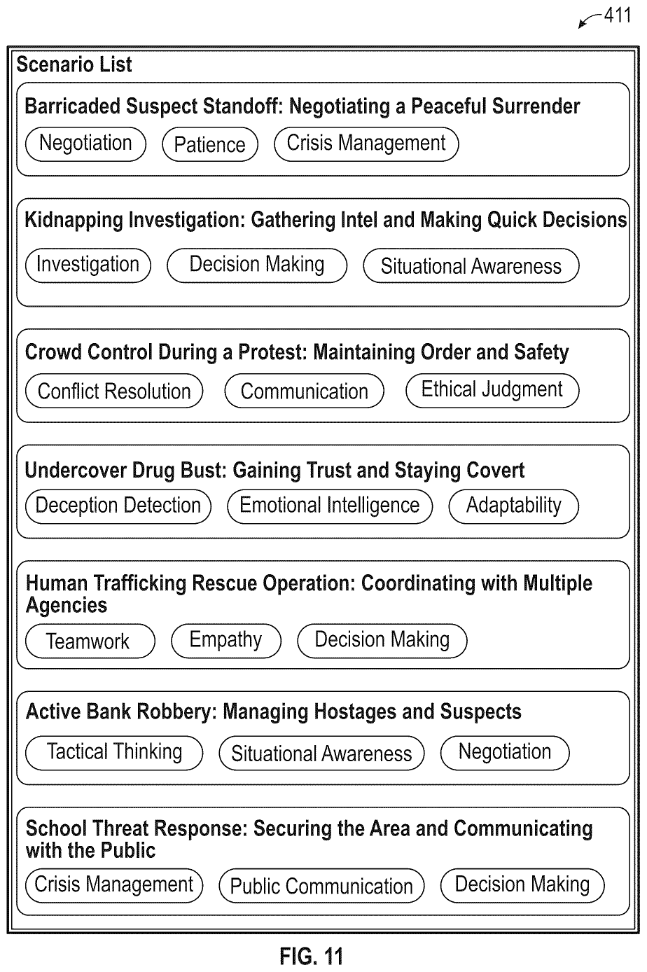

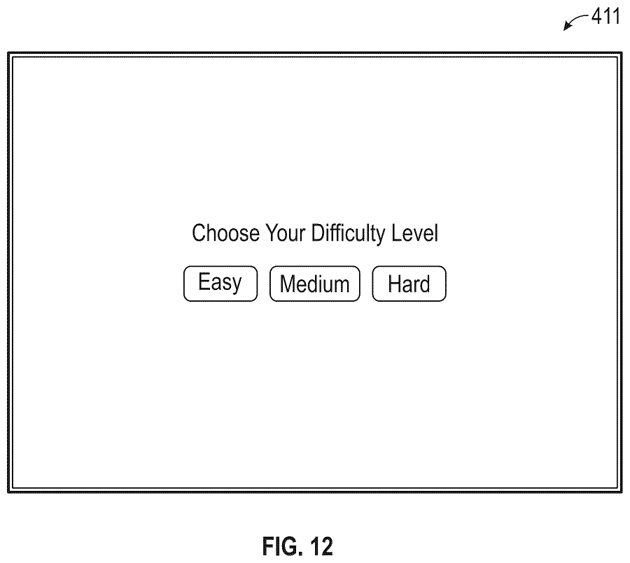

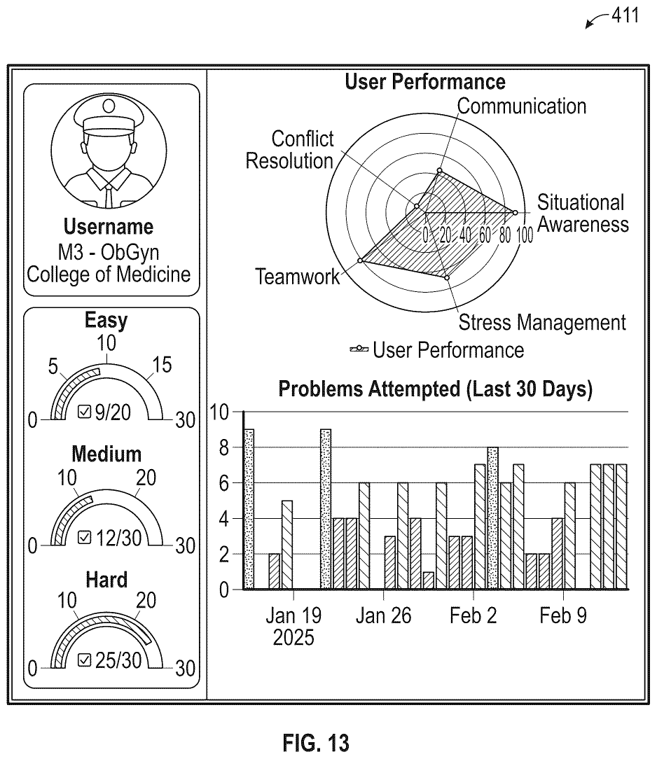

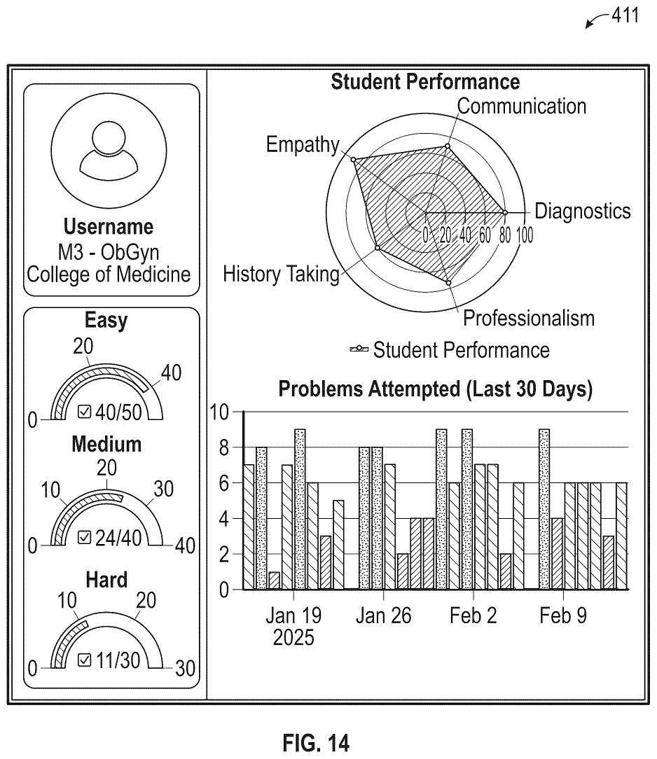

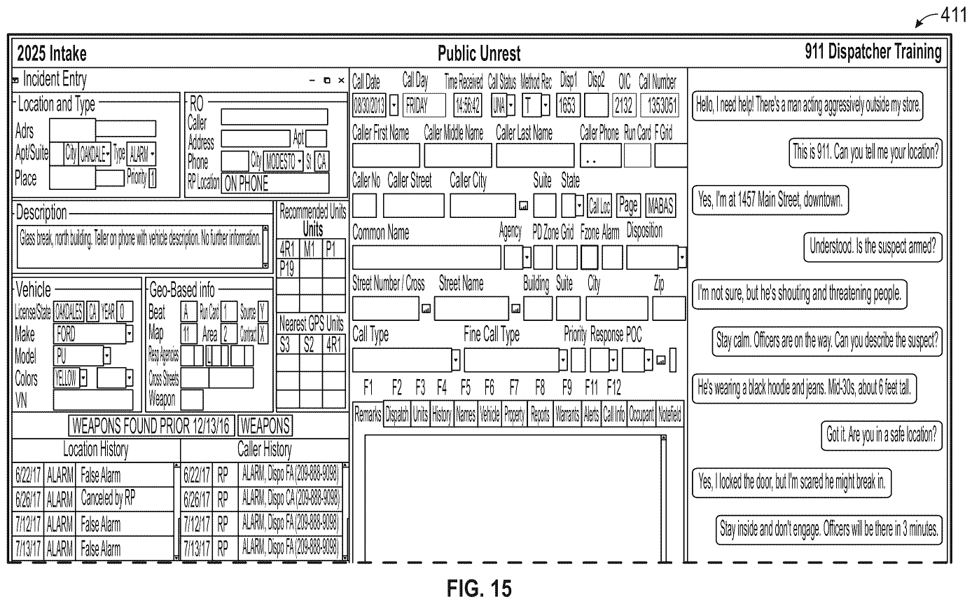

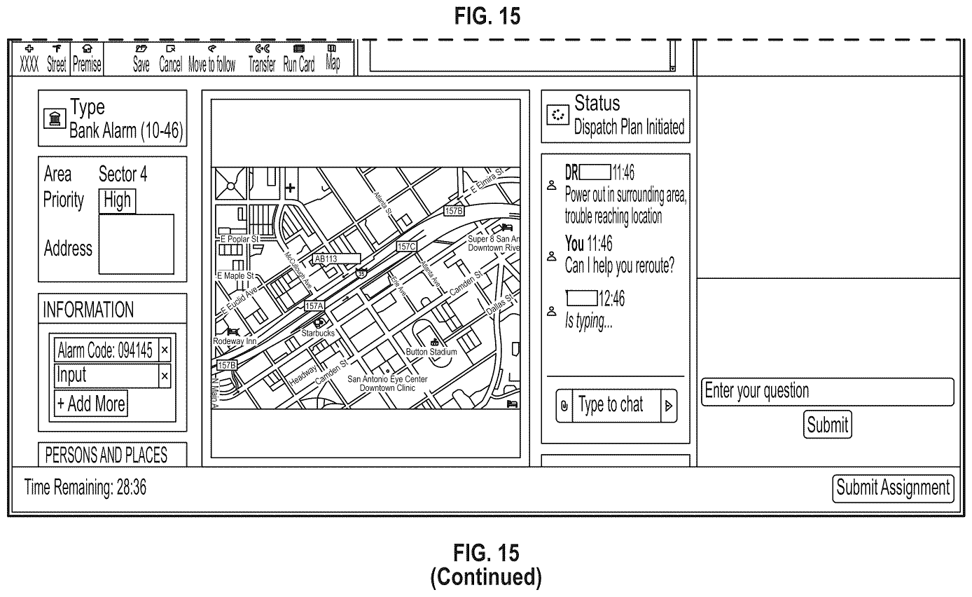

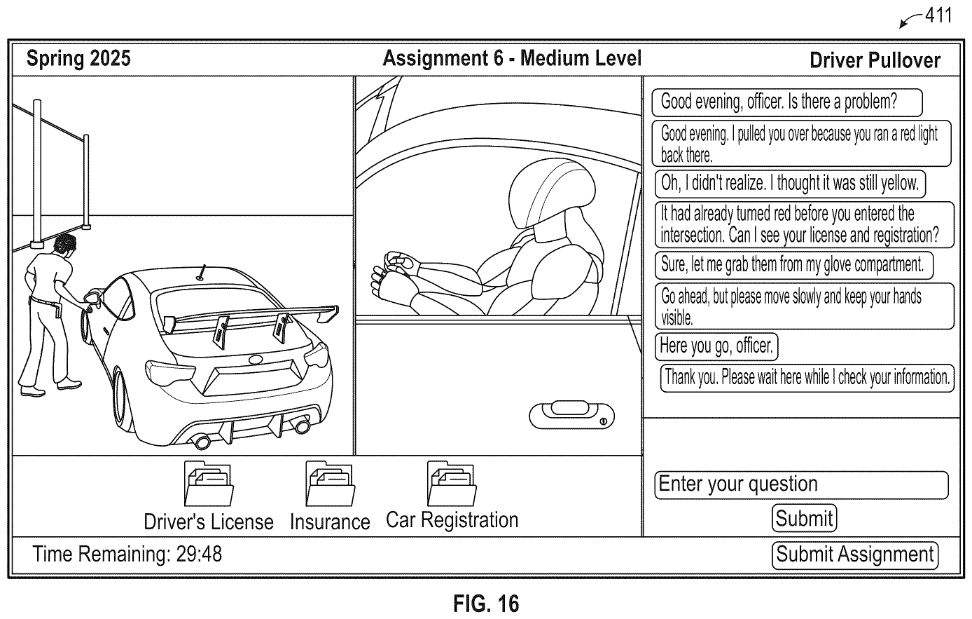

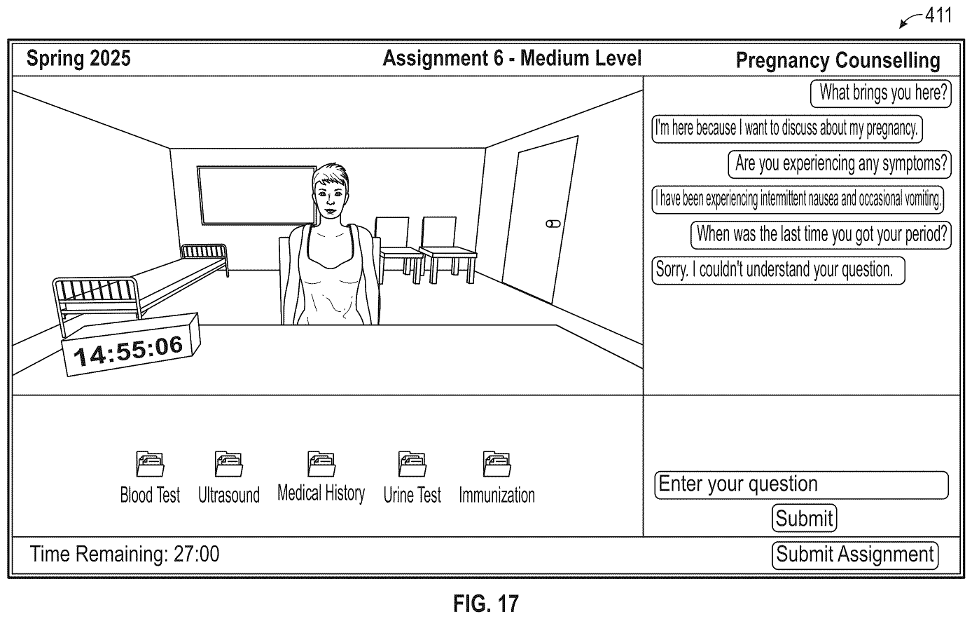

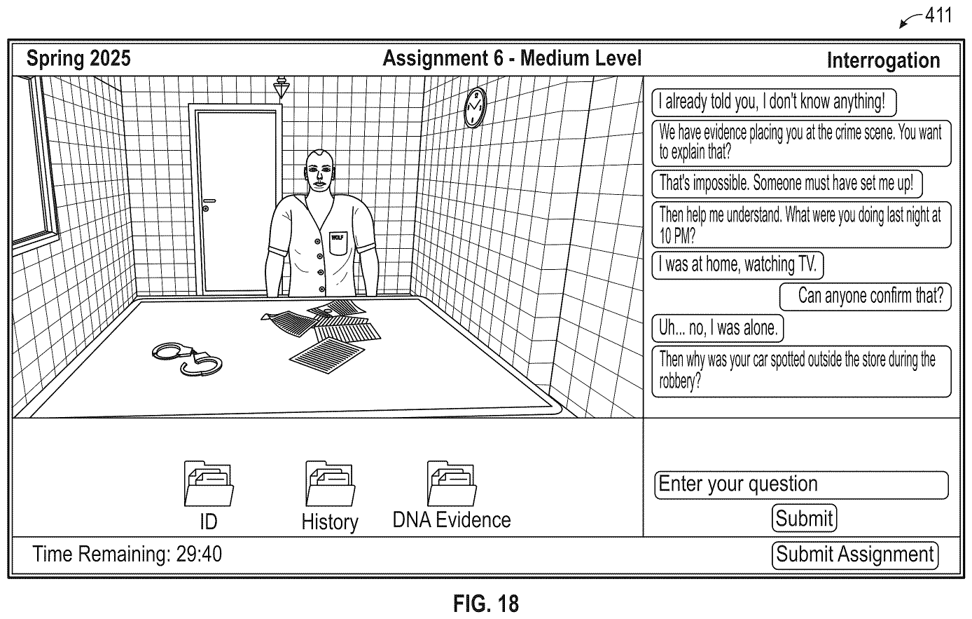

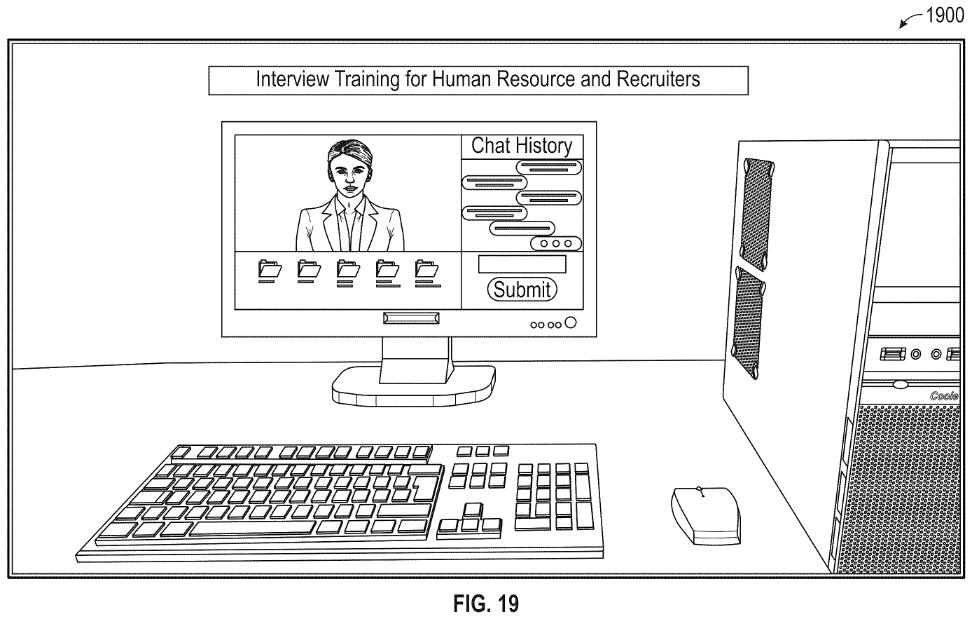

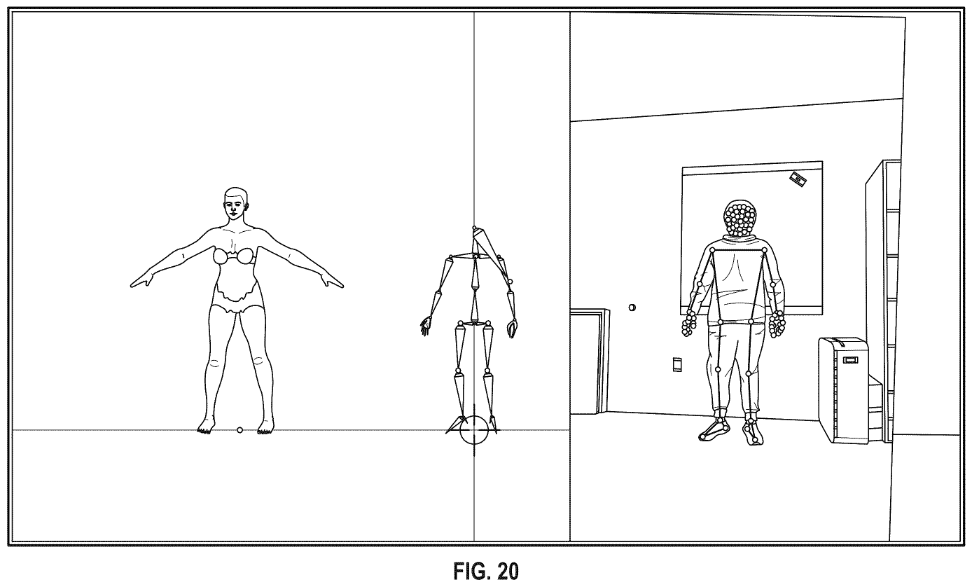

FIGS. 4-20 illustrate embodiments of a system 400 for training professionals on how to interact with others while acting in accordance with their profession, especially in regards to cultural sensitivity and decision-making. FIG. 4 illustrates a preferred embodiment of the system 400 having a computing device 410, display 316, and a processor 220 operably connected to said computing device and display. FIG. 5 illustrates an example user interface 411 of the computing device 410. FIG. 6 illustrates a simulated patient interaction 600 having a patient avatar, vital signs, and input data 615 from a user 405. FIG. 7 illustrates an array of potential training data 430D that may be used by the system 400 to generate a simulated interaction. FIG. 8 illustrates permission levels 800 that may be utilized by the present system 400 for controlling access to the various data of the system such as user data 430A, image data 430B, avatar data 430C, and training data 430D. FIG. 9 illustrates a user interface 411 presenting assigned scenarios for training users in various high-stakes and culturally sensitive situations across different professional domains. FIG. 10 illustrates scenarios that may be chosen within the user interface for medical training purposes, including emergency room triage, pediatric diagnosis, and cardiac arrest response scenarios. FIG. 11 illustrates scenarios that may be chosen within the user interface for law enforcement training, including barricaded suspect standoff, kidnapping investigation, and crowd control scenarios. FIG. 12 illustrates how a user may choose a difficulty level of a scenario via a user interface, presenting options for easy, medium, and hard difficulty settings. FIG. 13 illustrates a dashboard of a user profile presented via a user interface, displaying performance metrics including a radar chart and problems attempted over time. FIG. 14 illustrates a dashboard of a user profile presented via a user interface, showing student performance across categories such as communication, diagnostics, professionalism, history taking, and empathy. FIG. 15 illustrates an emergency dispatcher scenario presented via a user interface, featuring data intake panels, map interfaces, and communication panels for location-based decision-making. FIG. 16 illustrates a law enforcement scenario presented via a user interface, depicting a driver pullover interaction with dialogue panels and document access options. FIG. 17 illustrates a pregnancy counseling scenario presented via a user interface, showing a clinical environment with a virtual patient avatar and dialogue options for sensitive counseling interactions. FIG. 18 illustrates an interrogation scenario presented via a user interface, featuring an interrogation room environment with dialogue panels and evidence access options. FIG. 19 illustrates an interview scenario presented via a user interface for human resources and recruiter training, displaying a virtual candidate and dialogue interaction capabilities. FIG. 20 illustrates how the system creates scenario models, showing the process of creating and manipulating virtual avatars including three-dimensional models and skeletal frameworks for animation. It is understood that the various method steps associated with the methods of the present disclosure may be carried out as operations by the system 400 shown in FIGS. 4-20.

Generally, the system 400 is designed to facilitate the training of welfare and safety personnel by simulating interactions in a learning platform utilizing artificial intelligence. As used herein, “welfare and safety personnel” refers to persons who, in the course of their typical duties, may reasonably anticipate to directly engage with another person or persons in order to mitigate a hazard to the life, health, or safety of that or another person. Persons and positions which may be classed as welfare and safety personnel include, but are not limited to: physicians, nurses, medical technologists, physician's assistants (PAs), certified nurse's aids (CNAs), 911 operators, agents of federal law enforcement like the Federal Bureau of Investigation, state police officers, local police officers, social workers, military personnel, members of the National Guard, hostage negotiators, firefighters, security personnel, and intelligence officers. As illustrated in FIG. 4, the system 400 comprises a computing device 410 having a user interface 411, a processor 220 operably connected to said computing device, and a non-transitory computer-readable medium 416 coupled to said processor 220 and having instructions stored thereon. The system 400 further comprises a server 110 and a database 115 operably connected to the processor 220, wherein data relating to user profiles 430 may be stored and retrieved. In a preferred embodiment, the system 400 utilizes machine learning techniques to generate simulated communications that reflect realistic interactions between welfare and safety personnel and simulated persons across a variety of professional contexts.

In a preferred embodiment, the welfare and safety personnel being trained by the system 400 is a clinical trainee engaged in medical education. The simulated interaction is based upon both clinical and cultural data points contained within training data 430D to better simulate patient interactions with a diversity of backgrounds. As illustrated in FIG. 7, the training data 430D may include patient vital signs, patient complaints, discoverable data, and background demographic details that influence how the simulated patient responds to trainee communications. Through verbal interactions with the simulated patient, the clinical trainee collects relevant data points, builds a rapport with the simulated patient, and makes clinical decisions about the simulated patient's case. These decisions may include instructions to collect clinical or biometric data, further question the simulated patient to acquire more symptom or clinically relevant information, make a diagnosis, generate a treatment plan, or conduct other clinical activities. In some preferred embodiments, the system 400 tracks these decisions and stores them as part of the training data associated with the user profile 430 for subsequent review by instructors or administrators.

In another preferred embodiment, the system 400 may be configured to train law enforcement professionals in scenarios requiring interpersonal communication and decision-making under pressure. As illustrated in FIG. 16, the user interface 411 may present a driver pullover scenario wherein the trainee must engage with a simulated driver, request documentation, and navigate the interaction while maintaining appropriate communication protocols. The system 400 generates simulated communications based upon the background data of the simulated person, which may include factors such as the person's demeanor, cultural background, and prior experiences with law enforcement. For instance, a simulated driver who has had negative prior interactions with police may exhibit heightened anxiety or defensiveness, requiring the trainee to employ de-escalation techniques. The system 400 evaluates the trainee's responses and adjusts a quantifiable rapport score based on the appropriateness and effectiveness of their communication. In some preferred embodiments, access to certain discoverable data about the simulated person may be contingent upon the trainee achieving a minimum rapport score during the interaction.

In a preferred embodiment, the system 400 supports training scenarios for emergency dispatchers who must gather information rapidly while managing callers in distress. As illustrated in FIG. 15, the user interface 411 may present a dispatch scenario with data intake panels, map interfaces, and communication panels that allow the trainee to coordinate responses to emergency situations. The simulated caller's communications are generated via machine learning techniques based upon the training data 430D, which may include the caller's emotional state, language proficiency, and the nature of the emergency being reported. For instance, a simulated caller reporting a medical emergency may speak rapidly and provide incomplete information, requiring the trainee to ask clarifying questions while maintaining a calm and reassuring tone. The system 400 records all simulated communications and trainee responses as training data associated with the user profile 430. In another preferred embodiment, the system 400 may present scenarios involving language barriers, wherein the simulated caller has limited proficiency in the trainee's language and the trainee must adapt their communication approach accordingly.

Through repeated interactions with simulated persons of differing backgrounds and professional requirements, the trainee develops interpersonal skills which are both technically sound and culturally sensitive, improving rapport and service quality alike. As illustrated in FIG. 9, the user interface 411 may present a selection of assigned scenarios spanning multiple professional domains, including medical, law enforcement, and emergency response contexts. In some preferred embodiments, the system 400 may recommend specific scenarios to trainees based upon their prior performance and identified areas for improvement. For instance, a trainee who has demonstrated difficulty navigating interactions with simulated persons from particular cultural backgrounds may be presented with additional scenarios featuring those backgrounds. The system 400 utilizes the training data 430D stored within the database 115 to generate progressively challenging scenarios as the trainee's skills develop. In a preferred embodiment, instructors with appropriate permission levels 800 may review the trainee's performance data and assign specific scenarios to address identified skill gaps.

As illustrated in FIG. 4, the system 400 generally comprises a computing device 410 having a user interface 411, a processor 220 operably connected to said computing device, and a non-transitory computer-readable medium 416 coupled to said processor 220 and having instructions stored thereon. The computing device 410 serves as the primary interface through which users 405 access the various features and functionalities of the system 400, including simulated interactions with virtual persons. In a preferred embodiment, the system 400 further comprises a display 316 operably connected to said computing device 410 via a display interface 316A, wherein the display 316 is configured to present visual information including patient avatars, vital signs, and dialogue exchanges during simulated interactions. The processor 220 executes the instructions stored on the non-transitory computer-readable medium 416 to perform operations associated with generating simulated communications, analyzing user responses, and calculating rapport scores. In some preferred embodiments, the processor 220 may be implemented as a chipset of chips that include separate and multiple analog and digital processors to handle the computational demands of machine learning techniques employed by the system 400. The non-transitory computer-readable medium 416 may comprise various forms of storage including magnetic discs, optical disks, solid-state memory devices, or combinations thereof suitable for storing the instructions and data necessary for system operation.

In another preferred embodiment, a database 115 may be operably connected to the processor 220, and the various data of the system 400 may be stored therein, including user data 430A, image data 430B, avatar data 430C, and training data 430D. As illustrated in FIG. 4, the database 115 is connected to a server 110, which facilitates data retrieval and storage operations between the processor 220 and the stored user profiles 430. The user data 430A comprises personal information that helps the system 400 identify users and their characteristics, such as name, demographic information, and professional credentials. The image data 430B comprises photographic or visual data elements used by the system 400 to generate and render patient avatars and clinical environments within the user interface 411. The avatar data 430C comprises information relevant to particular avatars that influence their reactions, personality traits, and behavioral responses during simulated interactions. The training data 430D comprises scenario-specific information including vital signs, patient complaints, discoverable data, and background demographic details that the machine learning techniques utilize to generate realistic simulated communications.

In some preferred embodiments, the displays 316 may further comprise a user interface 411 configured to present the various data of the system 400 therein, allowing users 405 to view and interact with simulated scenarios. For instance, the user interface 411 may present a simulated patient avatar alongside vital sign indicators and a dialogue panel for conducting patient interviews. In a preferred embodiment, the user interface 411 may include controls for selecting scenarios, adjusting difficulty levels, and reviewing performance metrics stored within the user profile 430. In yet another preferred embodiment, a wireless communication interface 280 may allow the processors 220 of the system 400 to receive and transmit the various data of the system therebetween, enabling remote access to training scenarios from multiple computing devices 410. The wireless communication interface 280 may support various communication protocols including Bluetooth, WiFi, and cellular data connections to accommodate different deployment environments. This connectivity allows trainees to access the system 400 from various locations while maintaining synchronization of their user data 430A and training progress with the central database 115.

In a preferred embodiment, a simulated interaction 600 is presented in the user interface 411 of a computing device 410, wherein the user 405 engages with a simulated person through text-based communications and visual representations. As illustrated in FIG. 6, the simulated interaction 600 displays a patient avatar alongside vital sign indicators and a dialogue exchange area where trainee communications and simulated patient responses are presented. The user interface 411 organizes the various elements of the simulated interaction 600 in a manner that allows the user 405 to observe the simulated person's visual appearance while simultaneously reviewing clinical data and conducting the dialogue. In another preferred embodiment, the simulated interaction 600 is displayed in the user interface 411 on a display 316 operably connected to the computing device 410 via the display interface 316A, enabling the presentation of high-resolution graphics and animations associated with the patient avatar. The display 316 may comprise various display technologies including liquid crystal displays, light emitting diode displays, or organic light emitting diode displays to render the visual components of the simulated interaction 600 with sufficient clarity for the user 405 to observe subtle visual cues. In some preferred embodiments, the display 316 may be configured to present the simulated interaction 600 in a full-screen mode or in a windowed mode alongside other system components such as reference materials or performance metrics stored within the user profile 430.

In a preferred embodiment, a user 405 logs into a user profile 430 of the system 400 before accessing the various features of the system 400, allowing the system 400 to verify the identity of the user 405 and retrieve associated user data 430A. The login process may require the user 405 to provide authentication credentials such as a username and password combination, biometric data, or multi-factor authentication tokens through the user interface 411 of the computing device 410. As illustrated in FIG. 4, the processor 220 operably connected to the computing device 410 receives the login credentials via a computer readable signal and compares the credentials against stored user data 430A within the database 115 to determine whether access should be granted. In some preferred embodiments, the system 400 may implement additional security measures such as session timeouts, failed login attempt limitations, or device recognition protocols to enhance the security of user authentication. The processor 220 communicates with the server 110 and database 115 to retrieve the user profile 430 associated with the verified credentials, including any permission levels 800 that govern the user's access to content within the system 400. Upon successful authentication, the system 400 establishes a secure session that maintains the user's authenticated state throughout their interaction with the system 400.

In another preferred embodiment, the user interface 411 of the computing device 410 allows the user 405 to input commands and navigate through the various features and functionalities of the system 400 following successful authentication. As illustrated in FIG. 5, the user interface 411 presents the user data 430A, image data 430B, avatar data 430C, and training data 430D in an organized manner that facilitates user interaction and data management. The processor 220 processes commands received from the user 405 through the user interface 411 and executes corresponding operations such as retrieving data from the database 115, initiating simulated interactions, or modifying user profile 430 settings. In some preferred embodiments, the user interface 411 may include navigation menus, search functionality, and filtering options that enable the user 405 to locate and access specific scenarios or training data 430D efficiently. The display 316 operably connected to the computing device 410 via the display interface 316A renders the visual components of the user interface 411, presenting information in a format that is accessible and comprehensible to the user 405. The system 400 may store user preferences and interface customizations within the user profile 430, allowing the user interface 411 to be personalized according to individual user requirements.

In some preferred embodiments, the displays 316 of the system 400 may be configured for remote communication, enabling users 405 to access the system 400 from geographically distributed locations. The communication interface 280 facilitates the transmission of data between the computing device 410 and remote servers 110 or databases 115 via the network 150, as illustrated in FIG. 1. For instance, a clinical trainee may access the system 400 from a home computer while the server 110 and database 115 are located at a medical institution, with all data transmission occurring securely over the network 150. In another preferred embodiment, multiple users 405 may simultaneously access the system 400 from different client 105 devices, with each user 405 maintaining an independent session associated with their respective user profile 430. The system 400 synchronizes user data 430A and training data 430D across sessions, ensuring that progress and performance metrics are consistently recorded regardless of which computing device 410 the user 405 employs to access the system 400. This remote access capability allows training programs to be conducted across multiple sites while maintaining centralized data management and administrative oversight through the server 110 and database 115 infrastructure.

In a preferred embodiment, the various data of the system 400 may be stored in user profiles 430. In a preferred embodiment, a user profile 430 is related to a particular user 405. A user 405 is preferably associated with a particular user profile 430 based on a username. However, it is understood that a user 405 may be associated with a user profile 430 using a variety of methods without departing from the inventive subject matter herein. Types of data that may be stored within user profiles 430 of the system 400 include, but are not limited to, user data 430A, image data 430B, avatar data 430C, and training data 430D. Some preferred embodiments of the system 400 may comprise a database 115 operably connected to the processor 220. The database 115 may be configured to store user data 430A, image data 430B, avatar data 430C, and training data 430D within user profiles 430 and/or separately.

As used herein, user data 430A may be defined as personal information of a user 405 that helps the system 400 identify the user 405 and their characteristics. In a preferred embodiment, user data 430A comprises identifying information such as a user's name, username, social security number, phone number, email address, and physical address. As illustrated in FIG. 4, the user data 430A is stored within the user profile 430 in the database 115 and is retrievable via instructions relayed through the user interface 411 of the computing device 410. In some preferred embodiments, user data 430A may further include demographic information such as gender, age, ethnicity, native language, and professional credentials that may influence how the system 400 generates simulated communications during training scenarios. For instance, a trainee's age or apparent experience level may affect the initial rapport score assigned by the system 400 when interacting with a simulated patient who harbors biases regarding clinician experience. In another preferred embodiment, user data 430A may include professional information such as the user's institutional affiliation, training program enrollment, specialty area, and years of experience in their respective field. As illustrated in FIG. 5, the user interface 411 of the computing device 410 displays user data 430A alongside other profile information including image data 430B, avatar data 430C, and training data 430D. The system 400 utilizes user data 430A to personalize the training experience by adjusting scenario parameters and simulated person responses based on the characteristics of the trainee engaging with the simulation.

As used herein, image data 430B may be defined as photographic or trace objects that represent the underlying pixel data of an area of an image element, which is created, collected, and stored using image constructor devices, such as a camera, scanner, or other optical capture mechanism. In a preferred embodiment, the image data 430B comprises visual representations that the system 400 utilizes to render patient avatars, clinical environments, and other graphical elements within the user interface 411. As illustrated in FIG. 4, the image data 430B is stored within the user profile 430 and may be retrieved via instructions relayed through the user interface 411 of the computing device 410. In some preferred embodiments, the system 400 may use image data 430B obtained via a scanning device and a secondary security device to confirm the identity of a user 405 prior to granting access to training scenarios or sensitive information stored within the database 115. The image data 430B may include facial recognition templates, identification document scans, or biometric visual data that the processor 220 compares against stored records to authenticate the user 405. In another preferred embodiment, the image data 430B comprises texture maps, color palettes, and visual assets that are applied to three-dimensional avatar models to create realistic representations of simulated patients with diverse physical characteristics.

In a preferred embodiment, the system 400 utilizes image data 430B to generate an avatar for a simulated patient and link it with a set of clinical parameters stored within the training data 430D. As illustrated in FIG. 6, the image data 430B is rendered within the user interface 411 to display the patient avatar alongside vital sign indicators and dialogue exchange areas during simulated interactions 600. For instance, a simulated patient data set with the clinical condition of chronic obstructive pulmonary disease might be linked to one or more particular avatars comprising image data 430B that visually depicts labored breathing animations and cyanotic skin coloration. In some preferred embodiments, the image data 430B may be dynamically modified during the simulated interaction 600 to reflect changes in the simulated patient's condition based on trainee actions or the progression of the scenario. The processor 220 retrieves the appropriate image data 430B from the database 115 and renders it through the display 316 via the display interface 316A to present a cohesive visual representation to the user 405. In another preferred embodiment, the image data 430B may include environmental assets such as examination room backgrounds, medical equipment representations, and lighting conditions that contribute to the authenticity of the simulated clinical setting presented within the user interface 411.

As used herein, avatar data 430C may be defined as information relevant to a particular avatar that might influence the avatar's reactions and personality during simulated interactions with users 405. In a preferred embodiment, the avatar data 430C comprises behavioral parameters that determine how the simulated person responds to various stimuli and communications from the trainee. As illustrated in FIG. 4, the avatar data 430C is stored within the user profile 430 in the database 115 and is retrievable via instructions relayed through the user interface 411 of the computing device 410. In some preferred embodiments, the avatar data 430C may include emotional state indicators, personality traits, communication preferences, and predispositions that affect the simulated person's demeanor throughout the interaction. For instance, an avatar configured with high anxiety parameters may exhibit nervous behaviors and provide shorter, more guarded responses to trainee inquiries. In another preferred embodiment, the avatar data 430C may include trust thresholds that determine how readily the simulated person shares sensitive information with the trainee based on the rapport established during the interaction. As illustrated in FIG. 6, the avatar data 430C works in conjunction with the training data 430D and input data 615 to dynamically alter the avatar's presentation and responses within the user interface 411. The processor 220 retrieves the avatar data 430C from the database 115 and applies the behavioral parameters to the machine learning techniques that generate simulated communications during the interaction. In some preferred embodiments, the avatar data 430C may be modified by administrators or instructors with appropriate permission levels 800 to create customized training scenarios that target specific interpersonal challenges.

As used herein, training data 430D may be defined as information relevant to a scenario in which said avatar is to be deployed to interact with said user 405. In a preferred embodiment, the training data 430D comprises scenario-specific parameters that govern how the simulated person behaves and responds during interactions with welfare and safety personnel. As illustrated in FIG. 7, the training data 430D includes patient vital signs, patient complaints, discoverable data, and background demographic details that collectively define the characteristics and responses of the simulated person within a given scenario. In some preferred embodiments, the training data 430D may be stored within the database 115 and retrieved by the processor 220 when a user 405 initiates a training scenario through the user interface 411 of the computing device 410. The training data 430D works in conjunction with the avatar data 430C to produce realistic simulated communications that reflect both the clinical or situational parameters and the personality characteristics of the simulated person. In another preferred embodiment, the training data 430D may be generated using machine learning techniques based on prompts provided by an administrator or instructor with appropriate permission levels 800, allowing for the creation of customized scenarios tailored to specific training objectives.

In a preferred embodiment, the user data 430A, image data 430B, avatar data 430C, and training data 430D may be utilized by the system 400 in various combinations to carry out the functions described herein. As illustrated in FIG. 4, the user profile 430 stored within the database 115 contains each of these data types, which the processor 220 retrieves and processes according to the instructions stored on the non-transitory computer-readable medium 416. In some preferred embodiments, the system 400 may correlate user data 430A with training data 430D to personalize the simulated interaction 600 based on the characteristics of the trainee engaging with the simulation. For instance, the system 400 may adjust the initial rapport score or modify the simulated communications based on demographic information contained within the user data 430A in conjunction with the background data 620F contained within the training data 430D. In another preferred embodiment, the image data 430B and avatar data 430C may be combined to generate patient avatars that exhibit visual characteristics and behavioral responses consistent with the clinical scenario defined by the training data 430D. The processor 220 coordinates the retrieval and application of these data types through the server 110 and database 115 to produce cohesive simulated interactions that reflect both the clinical parameters and the interpersonal dynamics specified by the training scenario. Accordingly, one with skill in the art will understand that user data 430A, image data 430B, avatar data 430C, and training data 430D may be used by the system 400 in multiple ways to carry out various functions of the system without departing from the inventive subject matter described herein.

In a preferred embodiment, the system 400 may comprise a plurality of input/output devices to enhance a simulation presented via the user interface 411 of the computing device 410. As illustrated in FIG. 4, the computing device 410 is operably connected to the processor 220, which facilitates communication between the various components of the system 400 including peripheral devices 270 that capture user data during simulated interactions. In some preferred embodiments, the system 400 may leverage image data 430B obtained via a camera operably connected to the computing device 410 to observe and analyze body language of users 405, enhancing the realism and effectiveness of the virtual simulations. By capturing detailed visual information through the camera, the system 400 can interpret non-verbal cues such as posture, gestures, and facial expressions, which are significant components of communication between welfare and safety personnel and the persons they serve. This capability allows the system 400 to provide users 405 with feedback on their own body language during interactions, helping them to refine their non-verbal communication skills as part of the training data 430D recorded for subsequent review. For instance, a clinical trainee who crosses their arms or avoids eye contact during a simulated patient interaction 600 may receive feedback indicating that such body language could negatively affect the rapport score with the simulated patient.

In another preferred embodiment, the system 400 can simulate realistic body language in virtual avatars rendered using the avatar data 430C and image data 430B, making interactions more lifelike and engaging for the user 405. As illustrated in FIG. 6, the patient avatar displayed within the user interface 411 may exhibit signs of discomfort or anxiety through subtle shifts in posture or hand movements, prompting users 405 to adjust their approach accordingly during the simulated interaction 600. The processor 220 retrieves the avatar data 430C from the database 115 and applies behavioral parameters via machine learning techniques to generate these non-verbal responses based on the background data 620F and the current rapport score of the interaction. In some preferred embodiments, the system 400 incorporates body language analysis to equip users 405 with the skills to interpret and respond to non-verbal signals in real-world scenarios, ultimately improving their interpersonal effectiveness when interacting with patients or other persons. The non-transitory computer-readable medium 416 coupled to the processor 220 contains instructions stored thereon that, when executed, cause the processor 220 to analyze the captured body language data and correlate it with the simulated communications 615 occurring during the interaction. This correlation allows instructors with appropriate permission levels 800 to review how a trainee's non-verbal communication affected the progression of the simulated scenario and the resulting changes to the rapport score.

In addition to cameras, the system 400 can utilize a variety of other peripheral devices 270 to gather data, enhancing the depth and accuracy of the simulations presented via the display 316. As illustrated in FIG. 3, the mobile computing device 350 may include an audio codec 360 that can be employed to capture audio inputs from the user 405, allowing the system 400 to analyze verbal communication and tone during scenarios that involve dialogue and interpersonal interactions with simulated persons. In a preferred embodiment, wearable sensors operably connected to the computing device 410 via the communication interface 280, such as heart rate monitors and motion trackers, can provide real-time physiological data offering insights into the user's stress levels and physical responses during simulations. These peripheral devices 270 can help tailor the training experience by adjusting scenario difficulty based on the user's physiological state, with such adjustments being recorded as part of the training data 430D associated with the user profile 430. In some preferred embodiments, haptic feedback devices may be integrated with the system 400 to simulate tactile interactions, providing users 405 with a more immersive experience by allowing them to feel physical sensations such as the resistance of a simulated medical instrument or the pulse of a simulated patient during examination.

In another preferred embodiment, eye-tracking technology may be utilized by the system 400 to monitor where users 405 focus their attention during a scenario, providing valuable data on their situational awareness and decision-making processes that is stored within the training data 430D. As illustrated in FIG. 4, the processor 220 operably connected to the computing device 410 processes the eye-tracking data and correlates it with the simulated interaction 600 to determine whether the user 405 observed relevant visual cues presented by the patient avatar or vital signs 610. For instance, a trainee who fails to notice a change in the simulated patient's displayed blood pressure may receive feedback indicating that they missed a significant clinical indicator during the interaction. In some preferred embodiments, the system 400 may utilize microphones connected via the communication interface 280 to capture and analyze the trainee's verbal responses, evaluating factors such as tone, pace, and clarity of speech as part of the rapport score calculation. The data gathered from these diverse input devices is transmitted to the server 110 and stored within the database 115 as part of the user profile 430, allowing instructors with administrator roles 870 to access comprehensive performance analytics. By incorporating these diverse data-gathering devices, the system 400 can create a more comprehensive and realistic training environment, enabling users 405 to develop a wide range of skills and competencies in a controlled yet dynamic setting that prepares them for real-world interactions with persons of varying cultural and socioeconomic backgrounds.

As mentioned previously, the system 400 may comprise a user interface 411. A user interface 411 may be defined as a space where interactions between a user 405 and the system 400 may take place. In a preferred embodiment, the interactions may take place in a way such that a user 405 may control the operations of the system 400, including initiating simulated interactions, selecting training scenarios, and reviewing performance data stored within the user profile 430. As illustrated in FIG. 4, the user interface 411 is presented via the computing device 410, which is operably connected to the processor 220 and the display 316 via the display interface 316A. The user interface 411 may include, but is not limited to, operating systems, command line user interfaces, conversational interfaces, web-based user interfaces, zooming user interfaces, touch screens, task-based user interfaces, touch user interfaces, text-based user interfaces, intelligent user interfaces, brain-computer interfaces, and graphical user interfaces, or any combination thereof. In some preferred embodiments, the user interface 411 may be configured to present simulated patient interactions 600 wherein the user 405 engages with a patient avatar and views vital signs 610 while inputting responses through text entry fields.

In another preferred embodiment, the system 400 may present data of the user interface 411 to the user 405 via a display 316 operably connected to the processor 220. A display 316 may be defined as an output device that communicates data that may include, but is not limited to, visual, auditory, cutaneous, kinesthetic, olfactory, and gustatory information, or any combination thereof. As illustrated in FIG. 5, the user interface 411 of the computing device 410 presents user data 430A, image data 430B, avatar data 430C, and training data 430D in an organized layout that facilitates navigation and data management by the user 405. In some preferred embodiments, the display 316 may comprise liquid crystal display technology, light emitting diode display technology, or organic light emitting diode display technology to render the visual components of the simulated interaction 600 with sufficient clarity for the user 405 to observe patient avatar expressions and vital sign indicators. For instance, a display 316 may present a soft copy of visual information via a liquid crystal display, wherein the hard copy of the visual information is stored on the non-transitory computer-readable medium 416 or within the database 115. In a preferred embodiment, the display 316 may also present auditory information through integrated speakers, allowing the system 400 to provide verbal feedback or simulate patient vocalizations during training scenarios.

In some preferred embodiments, the user interface 411 may comprise additional controls that allow users 405 of the system 400 to manipulate how the various data of the system 400 is presented within the user interface 411. As illustrated in FIG. 5, the user interface 411 of the computing device 410 presents user data 430A, image data 430B, avatar data 430C, and training data 430D in an organized layout, and the additional controls may enable users 405 to customize the arrangement, visibility, or formatting of these data elements according to their preferences or training requirements. In a preferred embodiment, access to these customization features is governed by permission levels 800 associated with the user profile 430, ensuring that only authorized users 405 may modify certain display settings or interface configurations. As illustrated in FIG. 8, the permission levels 800 determine which content and features each requesting user 805, 825, 845 may access, and these same permission structures may extend to interface customization capabilities within the system 400. For instance, the system 400 may be configured in a way such that a user 405 may only change the language settings of a virtual patient simulation should they have the appropriate permissions granted through their user role 810, 830, 850 or administrator role 870. In another preferred embodiment, the system 400 may be configured in a way such that a user 405 may zoom in and zoom out of image data 430B displayed within the user interface 411 only if they have a permission level 800 that grants that feature, thereby restricting certain visualization capabilities to users 405 with elevated access privileges. The processor 220 operably connected to the computing device 410 retrieves the permission level 800 from the database 115 and determines which interface controls are available to the user 405 based on the stored permission data associated with their user profile 430. In some preferred embodiments, instructors or administrators 865 with administrator roles 870 may have access to a broader range of interface customization options, including the ability to configure default display settings for trainees under their supervision or to lock certain interface elements to maintain consistency across training sessions.

Information presented via a display 316 may be referred to as a soft copy of the information because the information exists electronically and is presented for a temporary period of time. Information stored on the non-transitory computer-readable medium 416 may be referred to as the hard copy of the information. For instance, a display 316 may present a soft copy of visual information via a liquid crystal display (LCD), wherein the hardcopy of the visual information is stored on a local hard drive. For instance, a display 316 may present a soft copy of audio information via a speaker, wherein the hard copy of the audio information is stored in RAM. For instance, a display 316 may present a soft copy of tactile information via a haptic suit, wherein the hard copy of the tactile information is stored within a database 115. Displays 316 may include, but are not limited to, cathode ray tube monitors, LCD monitors, light emitting diode (LED) monitors, gas plasma monitors, screen readers, speech synthesizers, haptic feedback equipment, virtual reality headsets, speakers, and scent generating devices, or any combination thereof.

The database 115 may be operably connected to the processor 220 via wired or wireless connection. In a preferred embodiment, the database 115 is configured to store user data 430A, image data 430B, avatar data 430C, and training data 430D within user profiles 430. Alternatively, the user data 430A, image data 430B, avatar data 430C, and training data 430D may be stored within user profiles 430 on the non-transitory computer-readable medium 416. The database 115 may be a relational database such that the user data 430A, image data 430B, avatar data 430C, and training data 430D associated with each user profile 430 within the plurality of user profiles 430 may be stored, at least in part, in one or more tables. Alternatively, the database 115 may be an object database such that user data 430A, image data 430B, avatar data 430C, and training data 430D associated with each user profile 430 of the plurality of user profiles 430 may be stored, at least in part, as objects. In some instances, the database 115 may comprise a relational and/or object database and a server 110 dedicated solely to managing the user data 430A, image data 430B, avatar data 430C, and training data 430D in the manners disclosed herein.

In a preferred embodiment, the system 400 utilizes methods and frameworks of model-based systems engineering to systematically design, develop, and manage the simulations presented via the user interface 411 of the computing device 410. As illustrated in FIG. 4, the processor 220 operably connected to the computing device 410 executes instructions stored on the non-transitory computer-readable medium 416 to implement the model-based systems engineering approach across the various components of the system 400. This approach allows for the integration of the server 110, database 115, and computing device 410 within the simulation environment, ensuring that each element functions cohesively to provide a realistic training experience for welfare and safety personnel. The model-based systems engineering framework enables the system 400 to create detailed models that represent the interactions and dynamics of real-world scenarios stored within the training data 430D. For instance, a model representing a patient-clinician interaction may incorporate variables from the vital data 620C, patient complaints 620D, discoverable data 620E, and background data 620F to generate simulated communications that reflect authentic patient behaviors. The processor 220 retrieves these model parameters from the database 115 and applies them through machine learning techniques to produce simulated interactions 600 that adapt to user inputs received through the user interface 411.

In some preferred embodiments, the model-based systems engineering framework facilitates the incorporation of machine learning algorithms and artificial intelligence techniques to enhance the system's ability to generate realistic responses based on the avatar data 430C and training data 430D. As illustrated in FIG. 6, the simulated interaction 600 displays a patient avatar alongside vital signs 610 and input data 615, with each component governed by underlying models that define their behavior and interrelationships. The engineering framework supports the continuous improvement of the system 400 by allowing developers to update and refine models stored within the database 115 based on feedback and new insights gathered from user interactions. For instance, if trainees consistently struggle with scenarios involving patients from particular cultural backgrounds as indicated by the background data 620F, the system 400 may flag these patterns for review by administrators 865 with appropriate permission levels 800. In another preferred embodiment, the model-based approach enables the system 400 to validate the consistency of training scenarios by verifying that the relationships between vital data 620C, patient complaints 620D, and discoverable data 620E conform to established clinical parameters. The server 110 operably connected to the processor 220 maintains version control of the various models, allowing the system 400 to track changes and ensure that simulations remain relevant and effective in addressing current and emerging challenges across medical, law enforcement, and emergency response training contexts.

In a preferred embodiment, the system 400 utilizes a model-based patterns library to enhance the realism and effectiveness of the virtual simulations presented via the user interface 411 of the computing device 410. The model-based patterns library comprises a comprehensive collection of predefined patterns and templates stored within the database 115 that represent various scenarios, interactions, and behaviors encountered in real-world settings across multiple professional domains. As illustrated in FIG. 4, the processor 220 operably connected to the computing device 410 retrieves pattern data from the database 115 via the server 110 and applies these patterns to generate simulated communications that reflect authentic interpersonal dynamics. The patterns within the library may include communication templates that define how simulated persons respond to specific types of inquiries, emotional state progressions that govern how a simulated person's demeanor changes throughout an interaction, and cultural response modifiers that adjust simulated communications based on the background data 620F associated with the simulated person. For instance, a pattern template for a simulated patient experiencing anxiety may define a sequence of verbal responses that become progressively more cooperative as the trainee demonstrates empathy and active listening skills. The model-based patterns library enables the system 400 to generate contextually appropriate responses without requiring the machine learning techniques to derive every response from first principles, thereby improving both the consistency and computational efficiency of the simulated interactions.

In some preferred embodiments, the model-based patterns library is organized into hierarchical categories that correspond to different professional training contexts supported by the system 400. As illustrated in FIG. 9, the user interface 411 presents assigned scenarios spanning medical, law enforcement, and emergency response domains, and the model-based patterns library contains distinct pattern sets tailored to each of these professional contexts. The medical pattern set may include templates for patient-clinician interactions involving symptom disclosure, treatment plan discussions, and informed consent conversations, while the law enforcement pattern set may include templates for traffic stop communications, witness interviews, and de-escalation dialogues. In another preferred embodiment, the patterns within each category are further subdivided based on the cultural and demographic characteristics defined in the background data 620F, allowing the system 400 to select patterns that reflect how individuals from different backgrounds may respond to similar situations. For instance, a pattern for discussing sensitive medical information may include variations that account for cultural norms regarding privacy, family involvement in medical decisions, and attitudes toward authority figures in healthcare settings. The hierarchical organization of the model-based patterns library allows the processor 220 to efficiently locate and apply relevant patterns based on the scenario identifier and background data 620F retrieved from the training data 430D stored within the database 115.

In another preferred embodiment, the model-based patterns library enables the system 400 to adapt to different training needs by providing modular pattern components that can be combined and customized according to specific learning objectives. As illustrated in FIG. 7, the training data 430D includes patient vital signs, patient complaints, discoverable data, and background demographic details, and the model-based patterns library contains pattern templates that define how these data elements influence the simulated person's responses during interactions. The modular design allows instructors with appropriate permission levels 800 to configure scenarios by selecting and combining patterns from the library rather than creating entirely new response logic for each training exercise. For instance, an instructor preparing a scenario for emergency dispatcher training may combine a high-stress caller pattern with a language barrier modifier pattern to create a challenging scenario that tests multiple competencies simultaneously. In some preferred embodiments, the system 400 may automatically suggest pattern combinations based on the trainee's prior performance data stored within the user profile 430, identifying areas where additional practice would be beneficial. The non-transitory computer-readable medium 416 coupled to the processor 220 contains instructions that govern how patterns from the library are selected, combined, and applied during the generation of simulated communications via the machine learning techniques employed by the system 400.

In a preferred embodiment, the model-based patterns library supports continuous improvement of the simulations by incorporating new patterns and insights derived from user interactions and feedback. The server 110 operably connected to the processor 220 may aggregate data from multiple training sessions conducted across the system 400 to identify patterns of trainee behavior and simulated person responses that correlate with successful learning outcomes. As illustrated in FIG. 13, the user interface 411 presents performance metrics including communication, situational awareness, stress management, teamwork, and conflict resolution scores, and these metrics may inform the refinement of patterns within the library to better target skill development in areas where trainees commonly struggle. In some preferred embodiments, administrators 865 with administrator roles 870 may review aggregated performance data and approve updates to the model-based patterns library that reflect evolving real-world challenges and expectations in their respective professional fields. For instance, changes in clinical practice guidelines or law enforcement protocols may necessitate updates to the patterns that govern how simulated persons respond to specific procedures or communication approaches. The system 400 maintains version control of the model-based patterns library within the database 115, allowing administrators to track changes over time and ensure that training scenarios remain current and aligned with professional standards across medical, law enforcement, emergency response, and other welfare and safety personnel training contexts.

The system 400 preferably uses machine learning techniques to perform the methods disclosed herein, wherein the instructions carried out by the processor 220 for said machine learning techniques are stored on the non-transitory computer-readable medium 416, server 110, and/or database 115. As illustrated in FIG. 4, the processor 220 is operably connected to the non-transitory computer-readable medium 416, which contains the instructions that govern how the machine learning techniques process data and generate outputs during simulated interactions 600. The machine learning techniques enable the system 400 to analyze trainee communications, generate contextually appropriate simulated person communications based on cultural and demographic background data, and dynamically adjust the rapport score in response to trainee actions. In a preferred embodiment, the system 400 retrieves training data 430D from the database 115 via the server 110 and applies the machine learning techniques to produce realistic simulated communications that reflect the characteristics defined within the background data 620F. The processor 220 executes the stored instructions to coordinate the retrieval of avatar data 430C and training data 430D, the generation of simulated communications, and the calculation of rapport scores throughout each training scenario. In some preferred embodiments, the machine learning techniques may be distributed across multiple computing entities, with the server 110 handling computationally intensive operations while the computing device 410 manages user interface 411 interactions and display 316 rendering via the display interface 316A.

In a preferred embodiment, the system 400 utilizes decision tree algorithms to generate simulated communications, analyze user responses, calculate rapport scores, and perform the various training functions described herein. Decision tree algorithms provide a structured approach to processing the multiple variables contained within the training data 430D and avatar data 430C to produce appropriate outputs during simulated interactions 600. As illustrated in FIG. 6, the simulated interaction 600 involves the exchange of input data 615 between the user 405 and the simulated person, with the decision tree algorithms determining how the simulated person responds based on the current state of the interaction and the underlying training data 430D. The decision tree structure allows the system 400 to evaluate multiple conditions simultaneously, such as the current rapport score, the content of the trainee's most recent communication, and the background data 620F of the simulated person, to select an appropriate response from among available options. In another preferred embodiment, the decision tree algorithms may incorporate branching logic that accounts for the sequence of prior communications within the interaction, enabling the simulated person to reference earlier statements or exhibit memory of previous exchanges. The hierarchical nature of decision trees enables the system 400 to process complex combinations of input variables efficiently while maintaining interpretability of the decision-making process for administrators 865 who may review system behavior.

In some preferred embodiments, the decision tree algorithms employed by the system 400 for generating realistic simulated communications based on background data 620F and training data 430D include implementations of classification and regression tree (CART), iterative dichotomiser 3 (ID3), C4.5 and C5.0, chi-squared automatic interaction detection (CHAID), decision stump, M5, conditional decision trees, random forest, gradient boosting machines (GBM), gradient boosted regression trees (GBRT), bootstrapped aggregation (bagging), and adaboost. Each of these algorithms offers distinct characteristics that may be advantageous for different aspects of the system 400 operations, and the processor 220 may select among available algorithms based on the specific task being performed. For instance, random forest algorithms may be employed when generating simulated communications that require consideration of numerous background data 620F variables simultaneously, as the ensemble approach reduces the likelihood of overfitting to any single variable. As illustrated in FIG. 7, the training data 430D includes patient vital signs, patient complaints, discoverable data, and background demographic details, each of which may serve as input features for the decision tree algorithms when determining appropriate simulated person responses. In another preferred embodiment, gradient boosting machines may be utilized for calculating and adjusting the rapport score, as these algorithms excel at capturing subtle relationships between trainee actions and the resulting changes in simulated person trust or cooperation. The system 400 may store multiple trained decision tree models within the database 115, with each model optimized for a particular type of scenario or professional domain such as medical, law enforcement, or emergency dispatch training contexts.

In a preferred embodiment, the decision tree algorithms analyze trainee communications 615B by parsing the text input received via the user interface 411 and evaluating the content against multiple criteria derived from the training data 430D. The parsing process may involve natural language processing techniques that identify key phrases, sentiment indicators, and communication style markers within the trainee's input. As illustrated in FIG. 4, the processor 220 receives the trainee communication via the computing device 410 and applies the decision tree algorithms stored on the non-transitory computer-readable medium 416 to determine the appropriate system response. For instance, a decision tree analyzing a trainee communication in a medical scenario may first evaluate whether the communication contains a question, a statement, or a request for action, then branch to evaluate the specific content based on the identified communication type. In some preferred embodiments, the decision tree algorithms may assign confidence scores to their classifications, allowing the system 400 to request clarification from the trainee when the input is ambiguous or does not clearly match any expected communication pattern. The analysis results are then utilized by subsequent decision tree algorithms to generate the simulated person's response and to calculate any adjustments to the rapport score based on the appropriateness of the trainee's communication.

In another preferred embodiment, the decision tree algorithms generate contextually appropriate patient communications 615A based on the simulated patient's cultural and demographic background as defined within the background data 620F. The generation process involves traversing decision tree structures that incorporate variables such as the simulated person's native language proficiency, cultural norms regarding authority figures, prior experiences with the trainee's profession, and current emotional state as modified by the ongoing interaction. As illustrated in FIG. 7, the background data 620F may indicate characteristics such as ethnicity, language proficiency, and socioeconomic factors that influence how the simulated person communicates and responds to trainee inquiries. For instance, a decision tree generating a response for a simulated patient with limited English proficiency may select vocabulary and sentence structures that reflect the specified proficiency level while still conveying the intended clinical information. In some preferred embodiments, the decision tree algorithms may incorporate randomization at certain branch points to introduce variability in simulated person responses, preventing trainees from memorizing specific response patterns across repeated interactions with similar scenarios. The generated communications are then rendered within the user interface 411 and displayed to the user 405 via the display 316, with the avatar data 430C and image data 430B providing visual accompaniment to the textual response.

In a preferred embodiment, the decision tree algorithms dynamically adjust the rapport score in response to trainee actions during simulated interactions 600, with the adjustment magnitude and direction determined by the combination of the trainee's action and the simulated person's background characteristics. The rapport score adjustment process involves evaluating the trainee's most recent action against criteria defined within the training data 430D and the avatar data 430C to determine whether the action would increase, decrease, or maintain the current rapport level. As illustrated in FIG. 8, the permission levels 800 govern access to the training data 430D that defines the rapport adjustment criteria, ensuring that only users 405 with appropriate administrator roles 870 may modify the underlying decision tree parameters. For instance, a decision tree evaluating a trainee's use of medical terminology may determine that excessive jargon without explanation decreases rapport with a simulated patient whose background data 620F indicates limited formal education, while the same terminology usage may have no effect or a positive effect with a simulated patient whose background indicates medical profession familiarity. In some preferred embodiments, the decision tree algorithms may implement threshold-based adjustments wherein small deviations from optimal communication result in minor rapport changes while significant communication failures trigger larger adjustments. The cumulative rapport score is stored within the training data associated with the user profile 430 and may be reviewed by instructors with appropriate permission levels 800 to assess trainee performance across multiple simulated interactions.

In a preferred embodiment, the machine learning techniques comprise instructions configured to create trained machine learning models from at least some training data 430D and according to an implementation of the machine learning techniques, wherein the training data 430D serves as a baseline dataset that may act as the foundational data of the machine learning techniques. As illustrated in FIG. 4, the processor 220 operably connected to the computing device 410 executes the instructions stored on the non-transitory computer-readable medium 416 to implement the machine learning techniques that generate simulated communications and calculate rapport scores during training scenarios. The instructions of the machine learning techniques dictate how the machine learning techniques gain knowledge from the various data sources of the system 400, including the user data 430A, image data 430B, avatar data 430C, and training data 430D stored within the database 115. In some preferred embodiments, the instructions may comprise various types of programmable instructions that include, but are not limited to, local commands, remote commands, executable files, protocol commands, selected commands, or any combination thereof. The instructions of the machine learning techniques may vary widely depending on a desired implementation and the specific training objectives of the scenario being executed. For instance, instructions for a medical training scenario may prioritize analysis of clinical terminology usage and empathy indicators, while instructions for a law enforcement scenario may emphasize de-escalation language patterns and situational awareness cues.

In another preferred embodiment, the instructions may include streamlined instructions that instruct the machine learning techniques on how to train the system 400, possibly in the form of a script utilizing programming languages such as Python, Ruby, or JavaScript. As illustrated in FIG. 7, the training data 430D includes patient vital signs, patient complaints, discoverable data, and background demographic details, each of which may be processed according to the scripted instructions to generate appropriate simulated person responses. The processor 220 retrieves the scripted instructions from the non-transitory computer-readable medium 416 and executes them in conjunction with the training data 430D retrieved from the database 115 via the server 110. In some preferred embodiments, the instructions may include data filters or data selection criteria that define requirements for desired result sets created from the various data of the system 400 as well as which machine learning algorithm is to be used for a particular operation. For instance, a data filter may specify that only background data 620F indicating limited English proficiency should be considered when generating simulated communications for a language barrier training scenario. The selection criteria may further specify that decision tree algorithms should be employed for analyzing trainee responses and adjusting the rapport score based on the cultural sensitivity demonstrated in the communication.

In a preferred embodiment, the baseline dataset comprises curated examples of interactions between welfare and safety personnel and persons from diverse cultural, ethnic, and socioeconomic backgrounds that have been validated by subject matter experts. As illustrated in FIG. 4, the database 115 operably connected to the server 110 stores the baseline dataset within the training data 430D, allowing the processor 220 to access the foundational data when initializing machine learning models for new training scenarios. The baseline dataset may include transcripts of successful patient-clinician interactions, recordings of effective de-escalation communications in law enforcement contexts, and examples of culturally sensitive emergency dispatch conversations. In some preferred embodiments, the baseline dataset is organized according to professional domain, cultural context, and scenario type to facilitate efficient retrieval and application by the decision tree algorithms. The processor 220 utilizes the baseline dataset to establish initial parameters for the machine learning techniques before the system 400 begins adapting to individual user performance patterns stored within the user profile 430. For instance, a baseline dataset for medical training may include examples of how patients from different cultural backgrounds describe symptoms of common conditions, enabling the decision tree algorithms to generate authentic simulated patient communications that reflect these linguistic and cultural variations.

Training of the machine learning techniques may be supervised, semi-supervised, or unsupervised depending on the specific application and the availability of labeled training data 430D within the database 115. In supervised training, the machine learning techniques receive labeled examples of appropriate and inappropriate trainee responses along with corresponding rapport score adjustments, enabling the decision tree algorithms to learn the relationships between communication patterns and interaction outcomes. In semi-supervised training, the machine learning techniques utilize a combination of labeled examples and unlabeled interaction data to develop more robust models that can generalize across diverse simulated person backgrounds defined within the background data 620F. In unsupervised training, the machine learning techniques may identify patterns and clusters within the training data 430D without explicit labels, which can be useful for discovering previously unrecognized relationships between trainee behaviors and simulated person responses. As illustrated in FIG. 4, the processor 220 operably connected to the computing device 410 executes the training procedures according to instructions stored on the non-transitory computer-readable medium 416, with the resulting trained models stored within the database 115 for subsequent retrieval during simulated interactions 600. In some preferred embodiments, the machine learning techniques may utilize natural language processing to analyze text data received via the user interface 411, enabling the system 400 to interpret trainee communications and generate contextually appropriate simulated person responses based on the avatar data 430C and training data 430D.

In a preferred embodiment, training of the machine learning techniques results in baseline machine learning models that serve as the foundational artificial intelligence techniques for performing the various functions of the system 400 in the manners described herein. The baseline machine learning models are derived from curated datasets that have been validated by subject matter experts to ensure accuracy and appropriateness for training welfare and safety personnel across medical, law enforcement, and emergency response contexts. As illustrated in FIG. 4, the baseline machine learning models are stored within the database 115 operably connected to the server 110, allowing the processor 220 to retrieve and apply these models when generating simulated communications during training scenarios. The baseline machine learning models may be further configured to operate as passive models or active models depending on the training objectives and the amount of user data 430A available within the user profile 430. A passive model may be described as a finalized machine learning model that utilizes only the baseline dataset to establish the behavior of the machine learning technique, providing consistent and predictable responses across all users 405 engaging with the system 400. An active model may be described as a dynamic machine learning model that incorporates both the baseline dataset and additional data acquired through user interactions, allowing the system 400 to adapt and personalize the training experience based on individual trainee performance patterns stored within the training data 430D.

In another preferred embodiment, the system 400 may utilize a passive model to maintain a high degree of control over how the system 400 manages simulated interactions 600 with welfare and safety personnel. The passive model configuration ensures that each user 405 of the system 400 receives the same simulated person scenario tuned to a particular background data 620F regardless of additional data obtained by the system 400 during prior interactions. As illustrated in FIG. 7, the training data 430D includes patient vital signs, patient complaints, discoverable data, and background demographic details that remain consistent across all trainees when the passive model is employed. This consistency is particularly useful for users 405 having user profiles 430 with limited historical data from which the decision tree algorithms may derive personalized recommendations. For instance, a new clinical trainee beginning their first simulated patient interaction 600 would receive the same scenario parameters and simulated patient responses as any other trainee at the same stage, ensuring equitable training conditions and enabling instructors with administrator roles 870 to compare performance across trainees using standardized metrics. The passive model approach also facilitates formal assessment scenarios where instructors require all trainees to navigate identical challenges to evaluate their competencies in cultural sensitivity and clinical decision-making.

In some preferred embodiments, the system 400 may be configured to begin with passive models until a threshold amount of user data 430A has been acquired through completed simulated interactions 600. The processor 220 operably connected to the computing device 410 monitors the quantity and quality of training data 430D associated with each user profile 430 to determine when sufficient data exists to support personalized recommendations. Once the threshold amount of user data 430A has been acquired, the system 400 may cause the decision tree algorithms to transition from passive models to active models, enabling the system 400 to generate recommendations that better reflect the historical performance patterns and identified skill gaps of the individual trainee. For instance, a system 400 may be configured to recommend a baseline set of simulated patient scenarios until a user's aptitude for navigating cultural interactions with patients from various backgrounds has been assessed through multiple completed interactions. Following this assessment, the system 400 may recommend simulated patient scenarios wherein the simulated patient has background data 620F indicating cultural characteristics or communication preferences that the trainee has previously struggled to navigate appropriately. As illustrated in FIG. 9, the user interface 411 presents assigned scenarios spanning multiple professional domains, and the active model configuration allows the system 400 to prioritize scenarios that address the specific developmental needs identified through analysis of the trainee's prior performance data.

In a preferred embodiment, an active machine learning model may be updated at various intervals including real-time, daily, weekly, bimonthly, monthly, quarterly, or annually using the various data of the system 400 such as updated model instructions, temporal adjustments, new or corrected private datasets, user data 430A, and training data 430D. The server 110 operably connected to the processor 220 coordinates the update process by aggregating new data from the database 115 and applying the decision tree algorithms to refine the model parameters based on the accumulated interaction records. As illustrated in FIG. 4, the non-transitory computer-readable medium 416 coupled to the processor 220 contains instructions that govern the update procedures, including validation checks to ensure that model updates do not introduce errors or degrade performance. In some preferred embodiments, the passive machine learning model may also be updated as new or revised private datasets become available, ensuring that the baseline training scenarios remain current with evolving professional standards and cultural considerations. For instance, updates to clinical practice guidelines or changes in law enforcement protocols may necessitate revisions to the passive model to ensure that simulated person responses and rapport score adjustments reflect contemporary expectations. The system 400 maintains version control of both passive and active models within the database 115, allowing administrators 865 with administrator roles 870 to track changes and revert to prior versions if necessary.

In another preferred embodiment, the machine learning techniques comprise metadata that describe the state of the passive or active model with respect to its updates and configuration parameters. The metadata may include attributes describing one or more of the following: a version number identifying the specific iteration of the model, a date indicating when the model was last updated, an amount of new data utilized for the most recent update, documentation of shifts in model parameters resulting from the update, convergence requirements that were applied during training, or other information relevant to model management. As illustrated in FIG. 8, the permission levels 800 govern access to the metadata and model configuration settings, ensuring that only users 405 with appropriate administrator roles 870 may view or modify the underlying model parameters. Because each user 405 of the system 400 may potentially have a unique active machine learning model associated with their user profile 430 due to the personalized nature of user data 430A and accumulated training data 430D, the metadata allows for identifying and managing distinct passive and active models within the system 400. For instance, an instructor reviewing trainee performance may access the metadata to determine which version of the model was active during a particular simulated interaction 600, enabling accurate interpretation of the rapport scores and simulated communications recorded during that session. The processor 220 retrieves the metadata from the database 115 via the server 110 and presents it through the user interface 411 to authorized users 405 who require access to model configuration information for administrative or analytical purposes.

FIG. 6 is a diagram illustrating a simulated interaction 600 with a simulated patient consistent with the principles of the present disclosure. As illustrated in FIG. 6, the simulated interaction 600 is presented via the user interface 411 of the computing device 410, displaying a patient avatar alongside vital sign indicators and a dialogue exchange area where trainee communications and simulated patient responses are presented. The clinical trainee receives simulated patient information from one or more sources within the simulated interaction 600, which guides their interpretation of the simulated patient's condition and informs the trainee's decision-making process throughout the scenario. The processor 220 operably connected to the computing device 410 retrieves the training data 430D from the database 115 via the server 110 and applies decision tree algorithms to generate the various components of the simulated interaction 600. In a preferred embodiment, the simulated interaction 600 integrates the image data 430B, avatar data 430C, and training data 430D to produce a cohesive clinical scenario that challenges the trainee to gather information, build rapport, and make appropriate clinical decisions. The display 316 operably connected to the computing device 410 via the display interface 316A renders the visual components of the simulated interaction 600 with sufficient clarity for the user 405 to observe patient avatar expressions, vital sign changes, and other visual indicators relevant to the clinical scenario.

In a preferred embodiment, the trainee gathers clinical data from examination of the patient avatar displayed within the user interface 411 during the simulated interaction 600. The patient avatar is rendered using the image data 430B and avatar data 430C stored within the database 115, with visual characteristics that may provide diagnostic clues to the observant trainee. For instance, a patient avatar that appears visibly jaundiced with yellowed skin and sclera might suggest to a trainee that the simulated patient has liver damage or biliary obstruction requiring further investigation. The decision tree algorithms employed by the processor 220 determine which visual characteristics are displayed based on the training data 430D associated with the scenario, ensuring consistency between the patient's appearance and their underlying clinical condition. In some preferred embodiments, the patient avatar may exhibit multiple visual indicators simultaneously, requiring the trainee to synthesize observations and prioritize their clinical inquiries accordingly. The system 400 records the trainee's observations and subsequent actions as part of the training data associated with the user profile 430, enabling instructors with appropriate permission levels 800 to review how effectively the trainee utilized visual information during the simulated interaction 600.

In another preferred embodiment, the patient avatar displayed within the simulated interaction 600 may comprise one or more animations that inform the trainee's decision-making process throughout the clinical encounter. The avatar data 430C stored within the database 115 includes behavioral parameters that govern how the patient avatar moves, gestures, and exhibits physical symptoms during the interaction. For instance, a visibly coughing patient avatar with labored breathing animations might suggest to a trainee that the simulated patient has a respiratory tract infection or other pulmonary condition warranting further evaluation. The decision tree algorithms process the avatar data 430C in conjunction with the training data 430D to determine which animations are displayed at specific points during the simulated interaction 600, with animation triggers potentially linked to the progression of the dialogue or changes in the rapport score. In some preferred embodiments, the patient avatar animations may change dynamically in response to trainee actions, such as exhibiting increased distress if the trainee fails to acknowledge the patient's discomfort or displaying relaxation if the trainee successfully establishes rapport through empathetic communication. The processor 220 coordinates the retrieval and application of animation data through the display interface 316A, ensuring that the visual presentation of the patient avatar remains synchronized with the simulated communications generated by the machine learning techniques employed by the system 400.

In a preferred embodiment, the trainee gathers clinical data from one or more patient vital signs 610 in a simulated interaction 600. As used herein, a vital sign is an objective physical or biological characteristic of a patient relevant to a medical professional routinely collected during a clinical visit and requiring little to no patient interaction besides passive compliance with a measurement. These vital signs may include but are not limited to age, sex, height, weight, body mass index (BMI), heart rate, blood pressure, temperature, or blood oxygenation. In one preferred embodiment, all the vital signs 610 the trainee may use to interpret the patient's condition are provided at the start of the simulated interaction 600. In another preferred embodiment, the trainee must instruct the system to collect all vital signs 610 on an individual basis through one or more non-communication commands. In yet another preferred embodiment, some vital signs are provided at the beginning of the interaction and some must be individually collected by the trainee with a non-communication command. In still another preferred embodiment, the collection of some vital signs must be first approved through a simulated communication 615. For instance, a simulated patient may passively comply with the measurement of height and weight but require simulated communication 615 before they will allow the collection of blood to measure blood sugar. In another example, the simulated patient may passively comply with most or all collection of vital signs, but rapid collection with no explanation or requests for permission in simulated communications 615 reduces a trust or rapport score, which may affect later communications or overall evaluation of the interaction. A simulated patient's compliance, noncompliance, response to vital collection, and requisite interactions pertaining to vital collection may be affected by a simulated patient demographic or cultural information 620F.

During a simulated interaction 600, the trainee must gather clinically relevant information by means of simulated communications 615. This clinically relevant information may include patient symptoms and related data, such as descriptors of pain, time of onset, activities which alleviate or exacerbate symptoms, activities conducted immediately prior to symptom onset, medical history, pharmacological history, and family medical history. Generally, the simulated communications are divided into patient communications 615A and trainee communications 615B. In a preferred embodiment, the patient communications 615A are generated using a machine learning technique based on training data 430D and the trainee communications 615B. For instance, the trainee might ask “What brings you to our clinic today” as an opening statement in a trainee communication 615B. Utilizing a machine learning technique, the system 400 would then respond with a patient communication 615A such as “My shoulder hurts,” thereby summarizing the primary patient complaint.

Machine learning techniques further enhance system functionality by not merely extrapolating basic requests for information, but simulating how a patient feels about clinical decisions. In a preferred embodiment, the training data 430D includes clinical information such as symptoms and vital signs in addition to cultural, linguistic, and demographic markers. In another preferred embodiment, the training data 430D includes a hidden rapport score, indicating a degree of trust or confidence the simulated patient has in the trainee. For instance, an elderly patient with a medical history involving repeated hospital-acquired infections might begin with a low rapport score to reflect a distrust for the medical system. By contrast, a teenager from a wealthy background and no chronic conditions might begin with a high rapport score to reflect a general confidence in successful treatment. This rapport score's initial starting value is adjusted up or down in response to trainee actions during the simulated interaction 600. For instance, a trainee who neglects to explain their actions or any ordered procedures could result in a rapport score reduction, while a trainee who carefully explains their reasoning could raise the rapport score by making the patient feel respected. In yet another preferred embodiment, changes in the rapport score may be influenced by the simulated patient's demographic or cultural information 620F. For instance, an impoverished patient with little formal education might reduce their rapport score if the trainee speaks with an overabundance of medical terminology that lacks explanation or elaboration. Alternatively, a trainee might substantially raise their rapport score if they successfully address a simulated patient with limited English fluency in said patient's native language.

The initial rapport score is not necessarily a fixed value identical for all trainees; a variety of irrational factors and characteristics of the trainee themselves might affect a patient's initial impression of the trainee. Preparing a trainee to face potential prejudice or phobia from a patient is a key component of cultural sensitivity training. In a preferred embodiment, the rapport score may be adjusted up or down either manually or using a machine learning technique based on factors in the user data 430A. For instance, a 23-year-old trainee might experience a reduction in initial rapport score to reflect a common societal prejudice against perceived inexperience in clinicians. In another preferred embodiment, the initial rapport score is adjusted up or down based on attributes specified in background data 620F in response to particular factors in the user data 430A. For instance, a simulated female patient may have an improved initial rapport score when interacting with a female trainee, particularly if the patient complaint 620D is related to conditions of the reproductive system or the simulated patient has a history of sexual assault requiring medical treatment. By contrast, a simulated patient from a culture where female clinicians are uncommon might begin with a lower rapport score. In another example, a simulated patient whose ethnicity is the same as the trainee's might have a higher initial rapport score. In yet another preferred embodiment, factors influencing initial rapport score are extrapolated using a machine learning technique, subjected to review by an instructor or administrator. In still another preferred embodiment, the system 400 utilizes a machine learning technique to incorporate the changes in initial rapport score based on user data 430A and background data 620F into simulated communication 615. For instance, a young trainee and not an older trainee might be given the question “How long have you been a doctor?” The response to this question might raise or lower the rapport score.

In a preferred embodiment, the rapport score comprises a plurality of individual scores to indicate individual interpersonal metrics, analyzed using a machine learning technique. These individual scores may include, but are not limited to, measures of empathy, active listening, cultural sensitivity, clarity of communication, and appropriate use of medical terminology. The machine learning technique may analyze various aspects of the trainee's interactions, such as word choice, tone, response time, and decision-making patterns, to generate these individual scores. For example, the empathy score might be influenced by the trainee's use of supportive language and acknowledgment of the patient's concerns, while the cultural sensitivity score could be affected by the trainee's ability to navigate cultural nuances and respect the patient's background. The active listening score may be determined by how well the trainee incorporates information provided by the patient into subsequent questions and decisions. By breaking down the overall rapport score into these constituent elements, the system provides more granular feedback to trainees, allowing them to identify specific areas for improvement in their patient interactions. This multi-faceted approach to scoring enables a more comprehensive evaluation of the trainee's interpersonal skills and their ability to build trust and rapport with patients from diverse backgrounds. It further may help instructors to differentiate between changes in rapport based on immutable aspects of the trainee's user data 430A and changes in rapport based on actions taken by the trainee.

FIG. 7 illustrates a diagram of an array of training data 430D consistent with the principles of the present disclosure. As illustrated in FIG. 7, the training data 430D is organized into distinct sections within the user interface 411, presenting patient information including vital signs, complaints, discoverable data, and background demographic details that collectively define the parameters of a simulated patient scenario. In a preferred embodiment, the training data 430D is not visible to trainees during simulated interactions 600 and utilizes one or more data security methods to restrict access to administrators 865 and instructors possessing appropriate permission levels 800. The processor 220 operably connected to the computing device 410 retrieves the training data 430D from the database 115 via the server 110 and applies the data to generate simulated communications through decision tree algorithms without exposing the underlying parameters to the trainee. As illustrated in FIG. 8, the permission levels 800 govern which users 405 may access the training data 430D, with administrator roles 870 typically required to view or modify scenario parameters stored within the database 115. This restriction ensures that trainees cannot anticipate simulated patient responses or adjust their approach based on knowledge of the expected clinical findings, thereby maintaining the educational integrity of the training exercise.

In another preferred embodiment, the ability to modify or generate training data 430D requires a different level of access than the level of access required to view said training data 430D, establishing a tiered permission structure within the system 400. As illustrated in FIG. 8, the permission levels 800 may be configured such that instructors possess viewing access to training data 430D while only administrators 865 with administrator roles 870 may create new scenarios or modify existing parameters stored within the database 115. This tiered approach allows instructors to review scenario content for quality assurance purposes while preventing unauthorized modifications that could compromise the consistency of training assessments across multiple trainees. In some preferred embodiments, the system 400 maintains an audit log within the database 115 that records all access attempts and modifications to training data 430D, enabling administrators 865 to track changes and identify any unauthorized access attempts. The processor 220 executes instructions stored on the non-transitory computer-readable medium 416 to verify the permission level 800 of each requesting user before granting access to view or modify training data 430D. For instance, a requesting user 2 825 with user 2 role 830 may be permitted to view training data 430D for scenarios they have been assigned to supervise but may be restricted from modifying the underlying clinical parameters or background data 620F.

In some preferred embodiments, training data 430D is generated using decision tree algorithms that process prompts provided by administrators 865 or instructors with appropriate permission levels 800. The decision tree algorithms analyze the input prompt and traverse branching logic structures to select appropriate values for vital data 620C, patient complaints 620D, discoverable data 620E, and background data 620F from reference datasets stored within the database 115. For instance, an administrator 865 might instruct the system 400 to generate data for a diabetic male patient in his late sixties, and the decision tree algorithms would evaluate this prompt to select age-appropriate vital signs, symptoms consistent with diabetes presentation, and demographic characteristics that align with the specified parameters. The processor 220 retrieves reference data from the database 115 via the server 110 and applies the decision tree algorithms to ensure that the generated training data 430D maintains clinical consistency across all data elements. The administrator 865 may then review the generated training data 430D through the user interface 411 to verify that there are no errors or outlier values that would compromise the educational validity of the scenario. In another preferred embodiment, a user 405 with appropriate permission levels 800 generates a scenario wholesale by manually entering clinical case data derived from anonymized real patient records, allowing the system 400 to incorporate authentic clinical presentations into the training program.

Training data 430D as used herein is defined as data of a particular simulated patient or patient interaction that is used by the system 400 to generate simulated communications 615 and vital signs 610 during training scenarios. As illustrated in FIG. 7, the training data 430D is presented within the user interface 411 in an organized format that displays the various data categories including patient vitals, complaints, discoverable data, and background demographic details. Generally, training data 430D comprises all the clinical data a trainee might need to make an appropriate diagnosis, treatment plan, or other clinical decision during a simulated interaction 600. The decision tree algorithms employed by the processor 220 utilize the training data 430D as input parameters when generating simulated patient communications 615A and determining how the simulated patient responds to trainee inquiries. In a preferred embodiment, the training data 430D comprises a patient name 620A and a scenario title 620B that identify the specific scenario and provide context for the training exercise. The scenario title 620B might be the same as the patient name 620A or a short descriptor to identify the function or focus of the scenario, such as the example shown in FIG. 7 where the scenario is titled “Recognizing Diabetes Presentation in ESL Patients” and the patient name is displayed as “Maura Rodriguez.”

In another preferred embodiment, the system 400 may generate a scenario title 620B using decision tree algorithms that analyze the training data 430D to identify the primary learning objectives and clinical focus of the scenario. The decision tree algorithms evaluate the vital data 620C, patient complaints 620D, and background data 620F to determine which clinical concepts are most prominently featured in the scenario and generate a descriptive title accordingly. For instance, a simulated patient with vital data 620C indicating elevated blood pressure and patient complaints 620D of headaches and dizziness might receive a generated scenario title 620B of “Identifying Hypertension in a Middle-Aged Patient with Nonspecific Symptoms.” In some preferred embodiments, the patient name 620A is provided to the trainee immediately upon the beginning of the scenario through the user interface 411, allowing the trainee to address the simulated patient appropriately from the outset of the interaction. In another preferred embodiment, the patient name 620A is not immediately provided to the trainee and failure to ask for a name and address the simulated patient by the name results in a reduction in the rapport score calculated by the decision tree algorithms. This configuration encourages trainees to practice proper patient identification protocols and demonstrates the importance of establishing a personal connection with patients through appropriate use of their names during clinical encounters.

Clinical data among training data 430D includes, but is not limited to, vital data 620C and patient complaints 620D that define the medical parameters of the simulated patient scenario. As illustrated in FIG. 7, the vital data 620C is displayed within the user interface 411 in a dedicated section labeled “Patient Vitals/Lab Results” and includes values such as age, sex, temperature, creatinine levels, height, weight, and heart rate. Vital data 620C is used by the system 400 to generate patient vital signs 610 that are displayed to the trainee during the simulated interaction 600, and no vital signs 610 may be provided to the trainee either initially or after taking vitals if there is no corresponding value in the vital data 620C stored within the training data 430D. The processor 220 retrieves the vital data 620C from the database 115 and renders the corresponding vital signs 610 through the display 316 via the display interface 316A when the trainee requests or collects vital sign measurements during the scenario. Patient complaints 620D comprise the primary conditions or symptoms prompting the patient to seek medical care, and as shown in FIG. 7, these complaints are displayed in a section labeled “Patient Complaints/Symptoms” listing items such as feeling more thirsty than usual, urinating often, and losing weight without trying. The decision tree algorithms utilize the patient complaints 620D to generate initial simulated patient communications 615A that describe the patient's presenting concerns when the trainee asks about the reason for the visit.

In a preferred embodiment, the patient complaints 620D may comprise common clinical scenarios that do not take the form of a complaint requiring a diagnosis, expanding the range of training situations available within the system 400. For instance, a simulated interaction 600 may be a medication refill requiring a mandatory checkup to ensure no adverse side effects are occurring, and such a scenario may have a patient complaint 620D of “out of medication” rather than a specific symptom or condition. In another example, a simulated interaction 600 may be a mandatory physical checkup required by an employer such as a school or transportation company, and such a scenario might have a patient complaint 620D of “general checkup” with no specific symptoms to investigate. These non-diagnostic scenarios allow trainees to practice routine clinical encounters that constitute a significant portion of real-world medical practice while still developing rapport-building and communication skills evaluated by the system 400. The decision tree algorithms process these non-diagnostic patient complaints 620D and generate appropriate simulated communications 615A that reflect a patient who is not experiencing acute symptoms but is present for administrative or preventive care purposes. In some preferred embodiments, the system 400 may incorporate unexpected findings into routine checkup scenarios, requiring the trainee to recognize abnormal values in vital data 620C or discoverable data 620E that warrant further investigation despite the patient's lack of presenting complaints.

In another preferred embodiment, the system 400 uses decision tree algorithms to correlate vital data 620C and patient complaints 620D, suggesting modifications to one based on values in the other to maintain clinical consistency within the training data 430D. The decision tree algorithms traverse branching logic structures that encode relationships between clinical parameters, identifying combinations of vital signs and symptoms that commonly occur together in real-world patient presentations. For instance, vital data 620C comprising a fasting blood sugar concentration of 130 mg/dL might be correlated by the decision tree algorithms with the patient complaint 620D “frequent urination,” a common symptom of diabetes that would be expected given the elevated glucose level. Similarly, a patient complaint 620D of constipation and abdominal pain might prompt the decision tree algorithms to suggest vital data 620C values corresponding with one or more types of inflammatory bowel disease, such as elevated inflammatory markers or abnormal complete blood count results. The processor 220 executes these correlation functions when administrators 865 create or modify training data 430D through the user interface 411, presenting suggested values that the administrator may accept, modify, or reject based on their clinical expertise. This correlation capability ensures that training scenarios maintain internal consistency and present clinically plausible patient presentations that prepare trainees for the patterns they will encounter in actual clinical practice.

Discoverable data 620E as used herein is clinical data that requires some form of input data 615 to be revealed to the trainee during a simulated interaction 600. In a preferred embodiment, discoverable data 620E includes details about patient complaints 620D that are not immediately apparent from the initial presentation of the simulated patient scenario. For instance, a patient complaint 620D of “pain in left shoulder” might have discoverable data 620E where the pain is described as “dull,” “burning,” and “occurs upon lifting arm laterally,” which the trainee must elicit through appropriate questioning via the user interface 411. As illustrated in FIG. 7, the discoverable data 620E is stored within the training data 430D in the database 115 and is retrievable by the processor 220 when the trainee provides appropriate input data 615 through the user interface 411 of the computing device 410. The decision tree algorithms employed by the system 400 evaluate the trainee's input data 615 to determine whether the communication satisfies the conditions for revealing specific discoverable data 620E to the trainee. In some preferred embodiments, the decision tree algorithms traverse branching logic structures that compare the trainee's inquiry against expected question patterns stored within the training data 430D to determine whether the discoverable data 620E should be disclosed.

In another preferred embodiment, discoverable data 620E comprises symptoms or conditions that the simulated patient experiences but does not volunteer as the reason they are seeking medical treatment. These additional symptoms may provide clues to a diagnosis, indicate a secondary medical condition needs addressing, comprise a medical history, or serve as red herrings to increase the difficulty of a simulated scenario. For instance, a simulated patient complaining of headaches might not disclose nosebleeds or a tingling sensation in its extremities unless directly asked by a trainee, though the symptoms together are highly suggestive of hypertension. As illustrated in FIG. 6, the input data 615 entered by the trainee through the user interface 411 is processed by the decision tree algorithms to determine whether the simulated patient should reveal additional discoverable data 620E based on the specificity and relevance of the trainee's inquiry. In some preferred embodiments, discoverable data 620E comprises the results of laboratory tests or other diagnostic procedures that require more than verbal communication through input data 615, such as an X-ray image that requires active patient consent to collect. The processor 220 retrieves the discoverable data 620E from the database 115 via the server 110 and presents it through the display 316 only after the decision tree algorithms confirm that the trainee has satisfied the requisite conditions for disclosure.

In a preferred embodiment, one or more pieces of discoverable data 620E require a certain rapport score before they will be disclosed to the trainee during the simulated interaction 600. The decision tree algorithms evaluate the current rapport score in conjunction with the trainee's input data 615 to determine whether the simulated patient will share sensitive information. For instance, a simulated patient with a low rapport score might not disclose the symptoms of a sexually transmitted disease to a trainee, reflecting the reluctance of real patients to share embarrassing or stigmatized information with healthcare providers they do not trust. As illustrated in FIG. 4, the processor 220 operably connected to the computing device 410 retrieves the current rapport score from the training data 430D stored within the database 115 and applies the decision tree algorithms to determine disclosure eligibility. In another preferred embodiment, a simulated patient with a high rapport score might disclose additional details of their condition unprompted to a trainee, reducing the difficulty in collecting clinical information and rewarding effective rapport-building communication. The decision tree algorithms may implement threshold-based logic wherein discoverable data 620E is categorized by sensitivity level, with more sensitive information requiring higher rapport scores before the simulated patient will volunteer or confirm the information in response to trainee inquiries.

Background data 620F as used herein comprises information about the simulated patient which is not directly relevant to the clinical details of the simulated interaction 600 but influences how the simulated patient communicates and responds to trainee actions. Background data 620F may comprise any of age, race, ethnicity, country of origin, sexual orientation, gender identity and its relationship to clinical sex, native language, proficiency in the trainee's language, political affiliation, religious affiliation, caste, tribe, degree of wealth, formal education, insurance status, marital status, parental status, or any other relevant cultural, social, or economic marker. As illustrated in FIG. 7, the background data 620F is displayed within the user interface 411 in a section labeled “Patient Background/Demographic Details” and includes characteristics such as ethnicity, age range, and language proficiency that collectively define the cultural context of the simulated patient. In a preferred embodiment, the system 400 uses decision tree algorithms to generate simulated patient communications 615A based on background data 620F stored within the training data 430D. The decision tree algorithms traverse branching logic structures that incorporate the background data 620F variables to select appropriate vocabulary, sentence structure, and cultural references for the simulated patient's responses. For instance, if the background data 620F indicates that the simulated patient is an elderly individual from a specific cultural background with limited English proficiency, the decision tree algorithms adjust the generated communications to reflect appropriate linguistic patterns and cultural communication norms.

In some preferred embodiments, the decision tree algorithms incorporate natural language processing techniques to understand and generate human-like text based on the background data 620F retrieved from the database 115. The processor 220 operably connected to the computing device 410 executes the decision tree algorithms stored on the non-transitory computer-readable medium 416 to analyze the trainee's input data 615 and generate contextually appropriate simulated patient communications 615A. As illustrated in FIG. 4, the server 110 and database 115 operably connected to the processor 220 store the background data 620F within the user profile 430, allowing the system 400 to retrieve and apply cultural parameters consistently throughout the simulated interaction 600. In another preferred embodiment, the decision tree algorithms may incorporate sentiment analysis and context understanding to ensure that simulated patient responses reflect appropriate emotional states based on the background data 620F and the current rapport score. The use of decision tree algorithms enables the system 400 to continuously improve its ability to generate authentic patient communications as more simulated interactions are conducted and feedback is incorporated into the training data 430D. As the model refines its understanding of how various background factors influence communication styles, preferences, and concerns in healthcare settings, the decision tree structures may be updated by administrators 865 with appropriate permission levels 800 to reflect these improvements.

In formal clinical training programs, the rapport score, breakdown of said score by individual metrics, and record of clinical decision making by a particular user 405 or group of users 405 may be analyzed by an instructor with appropriate permission levels 800. As illustrated in FIG. 8, the permission levels 800 govern access to the training data 430D stored within the database 115, ensuring that instructors with administrator roles 870 may review trainee performance data while trainees with user roles 810, 830, 850 may only access their own user content 815, 835, 855. This analysis allows for a comprehensive evaluation of the trainee's performance in the simulated patient interactions 600 conducted through the user interface 411 of the computing device 410. The instructor can review the overall rapport score to assess the trainee's general ability to build a positive relationship with the simulated patient, with the score data retrieved from the database 115 via the server 110 operably connected to the processor 220. By examining the breakdown of individual metrics, such as empathy, active listening, cultural sensitivity, clarity of communication, and appropriate use of medical terminology, the instructor can identify specific areas where the trainee excels or needs improvement. As illustrated in FIG. 13, the user interface 411 presents performance metrics including communication, situational awareness, stress management, teamwork, and conflict resolution scores in a radar chart format that facilitates visual comparison across competency areas.

In a preferred embodiment, the record of clinical decision making stored within the training data 430D provides insight into the trainee's diagnostic reasoning, treatment planning, and ability to apply medical knowledge in practical scenarios presented via the simulated interaction 600. By analyzing this data retrieved from the database 115, instructors with appropriate permission levels 800 can evaluate the trainee's clinical competence, critical thinking skills, and adherence to best practices in patient care. The combination of rapport scores and clinical decision-making records offers a holistic view of the trainee's performance, encompassing both interpersonal skills and medical expertise developed through interactions with the system 400. As illustrated in FIG. 14, the user interface 411 presents student performance data across categories including communication, diagnostics, professionalism, history taking, and empathy, allowing instructors to identify patterns in trainee development over time. In some preferred embodiments, instructors may use this data to track progress over time by comparing multiple simulations stored within the user profile 430 to identify trends and improvements in the trainee's skills. The cultural sensitivity score metric may differ between simulated cultures defined by the background data 620F, helping a trainee identify patient groups where they will have to take care to familiarize themselves with differing cultural norms.

In another preferred embodiment, the longitudinal analysis of trainee performance data stored within the database 115 can inform curriculum development and highlight areas where additional training resources may be needed within the medical education program. The processor 220 operably connected to the computing device 410 may aggregate data from multiple simulated interactions 600 to generate summary reports accessible through the user interface 411 by instructors with administrator roles 870. As illustrated in FIG. 13, the user interface 411 presents a bar graph showing problems attempted over the last thirty days, enabling instructors to monitor trainee engagement with the system 400 and identify users 405 who may require additional encouragement or support. The aggregated data from groups of users 405 can offer valuable insights into the effectiveness of the training program as a whole, allowing for continuous refinement and optimization of the simulation system 400 to better prepare future healthcare professionals for the complexities of patient care in diverse cultural contexts. In some preferred embodiments, the decision tree algorithms may analyze aggregated performance data to identify common areas of difficulty across trainee cohorts, enabling administrators 865 to prioritize the development of additional training scenarios that address identified skill gaps. The system 400 stores all performance analytics within the database 115 operably connected to the server 110, ensuring that historical data remains available for longitudinal studies and program evaluation purposes.

To prevent un-authorized users from accessing other user's information, the system 400 may employ a data security method. As illustrated in FIG. 8, the data security method of the system 400 may comprise a plurality of permission levels 800 that may grant users 405 access to user content 815, 835, 855 within the database while simultaneously denying users 405 without appropriate permission levels 800 the ability to view user content 815, 835, 855. To access the user content 815, 835, 855 stored within the database 115, users 405 may be required to make a request via a user interface 411. Access to the data within the database 115 may be granted or denied by the processor 220 based on verification of a requesting user's 805, 825, 845 permission level 800. If the requesting user's 805, 825, 845 permission level 800 is sufficient, the processor 220 may provide the requesting user 805, 825, 845 access to user content 815, 835, 855 stored within the database. Conversely, if the requesting user's 805, 825, 845 permission level 800 is insufficient, the processor 220 may deny the requesting user 805, 825, 845 access to user content 815, 835, 855 stored within the database. In an embodiment, permission levels 800 may be based on user roles 810, 830, 850 and administrator roles 870, as illustrated in FIG. 8. User roles 810, 830, 850 allow requesting users 805, 825, 845 to access user content 815, 835, 855 that a user 405 has uploaded and/or otherwise obtained through use of the system 400. Administrator roles 870 allow administrators 865 to access system 400 wide data.

In an embodiment, user roles 810, 830, 850 may be assigned to a user 405 in a way such that a requesting user 805, 825, 845 may view user profiles 430 containing ser data 430A, image data 430B, avatar data 430C, and training data 430D via a user interface 411. To access the data within the database 115, a user 405 may make a user request via the user interface 411 to the processor 220. In an embodiment, the processor 220 may grant or deny the request based on the permission level 800 associated with the requesting user 805, 825, 845. Only users 405 having appropriate user roles 810, 830, 850 or administrator roles 870 may access the data within the user profiles 430. For instance, as illustrated in FIG. 8, requesting user 1 805 has permission to view user 1 content 815 and user 2 content 835 whereas requesting user 2 825 only has permission to view user 2 content 835. Alternatively, user content 815, 835, 855 may be restricted in a way such that a user may only view a limited amount of user content 815, 835, 855. For instance, requesting user 3 845 may be granted a permission level 800 that only allows them to view user 3 content 855 related to their specific interest but not user 3 content 855 related to the identity of said user 405. In the example illustrated in FIG. 8, an administrator 865 may bestow a new permission level 800 on users 405 so that it may grant them greater permissions or lesser permissions. For instance, an administrator 865 may bestow a greater permission level 800 on other users 405 so that they may view user 3's content 855 and/or any other user's content 815, 835, 855. Therefore, the permission levels 800 of the system 400 may be assigned to users 405 in various ways without departing from the inventive subject matter described herein.

FIG. 9 illustrates a user interface 411 within the system 400, presenting a selection of assigned scenarios designed to train welfare and safety personnel in various high-stakes and culturally sensitive situations across multiple professional domains. As illustrated in FIG. 9, the user interface 411 displays scenario cards organized into distinct categories, with each card containing a representative image, a scenario title, and a brief description of the training focus and skills to be developed. In a preferred embodiment, the processor 220 operably connected to the computing device 410 retrieves scenario data from the database 115 via the server 110 and renders the available training options through the display 316 via the display interface 316A. The scenario selection interface allows users 405 to browse through available training exercises and select scenarios that align with their professional development objectives or assigned curriculum requirements. In some preferred embodiments, the decision tree algorithms employed by the system 400 may filter or prioritize the displayed scenarios based on the user data 430A associated with the user profile 430, presenting scenarios that are most relevant to the user's professional role and identified skill gaps. The navigation elements depicted in FIG. 9, including directional arrows and pagination indicators, enable users 405 to scroll through additional scenarios beyond those immediately visible on the display 316.

In another preferred embodiment, the scenario selection interface presents law enforcement training scenarios including a High-Tension Traffic Stop scenario focused on handling an agitated driver, an Active Shooter Response scenario emphasizing coordination under pressure, and a Suspicious Person Encounter scenario addressing the balance between caution and community relations. Each scenario card displays skill tags that identify the competencies to be developed through engagement with that particular simulation, such as de-escalation techniques, quick decision-making, and situational awareness. The decision tree algorithms process the skill tags in conjunction with the training data 430D to determine appropriate difficulty levels and simulated person responses for each scenario type. For instance, a law enforcement trainee selecting the High-Tension Traffic Stop scenario would engage with a simulated driver whose background data 620F influences their demeanor and responses throughout the interaction. In some preferred embodiments, the system 400 tracks which scenarios each user 405 has completed and stores this information within the user profile 430 in the database 115 for subsequent review by instructors with appropriate permission levels 800. The scenario descriptions provide users 405 with sufficient context to make informed selections while avoiding disclosure of specific training data 430D that would compromise the educational value of the simulation.

In a preferred embodiment, the scenario selection interface also presents medical training scenarios including a Pregnancy Counselling scenario for counseling sensitive pregnancy cases, an Emergency Room scenario for learning how to handle emergency cases, and a Surgical Procedures scenario focused on performing complex surgeries. As illustrated in FIG. 9, these medical scenarios are displayed in a separate section of the user interface 411, allowing users 405 to distinguish between professional domains when selecting training exercises. The decision tree algorithms employed by the processor 220 generate simulated patient communications 615A based on the training data 430D associated with each medical scenario, incorporating vital data 620C, patient complaints 620D, discoverable data 620E, and background data 620F to produce authentic clinical interactions. For instance, a trainee selecting the Pregnancy Counselling scenario would interact with a simulated patient whose cultural background and personal circumstances influence how she discusses sensitive reproductive health topics. In another preferred embodiment, the system 400 may recommend specific scenarios to users 405 based on their prior performance metrics stored within the user profile 430, with the decision tree algorithms analyzing patterns in rapport scores and clinical decision-making records to identify areas requiring additional practice. The comprehensive range of scenarios available through the user interface 411 ensures that welfare and safety personnel can develop both technical competencies and interpersonal skills necessary for effective performance in their respective professional contexts.

FIGS. 10 and 11 present user interface 411 screens within the system 400, each showcasing a curated list of scenarios designed to enhance specific skills and competencies across different professional domains. As illustrated in FIG. 10, the user interface 411 displays a scenario list tailored for medical training purposes, presenting five distinct scenarios arranged vertically within the display 316. The medical scenarios include Emergency Room Triage, Pediatric Diagnosis, Cardiac Arrest Response, Surgical Preparation, and Mental Health Consultation, each accompanied by skill tags that identify the competencies to be developed through engagement with that particular simulation. The processor 220 operably connected to the computing device 410 retrieves the scenario data from the database 115 via the server 110 and renders the available training options through the display 316 via the display interface 316A. Each scenario card within the user interface 411 displays the scenario title prominently along with associated skill tags shown as labeled buttons beneath the title, enabling users 405 to quickly identify which competencies will be addressed by each training exercise. The decision tree algorithms employed by the system 400 process the skill tag data in conjunction with the training data 430D to determine appropriate difficulty levels and simulated person responses for each medical scenario type.

In a preferred embodiment, the medical training scenarios presented in FIG. 10 are associated with skill tags that provide a comprehensive framework for medical professionals to practice and refine their clinical and interpersonal abilities. The Emergency Room Triage scenario includes skill tags for Critical Thinking, Decision Making, and Communication, reflecting the competencies required when prioritizing patient care in high-pressure emergency settings. The Pediatric Diagnosis scenario features skill tags for Diagnosis, Patient Interaction, and Empathy, addressing the unique challenges of communicating with young patients and their families while gathering clinical information. The Cardiac Arrest Response scenario is tagged with Emergency Handling, CPR, and Decision Making, emphasizing the rapid assessment and intervention skills necessary during life-threatening cardiac events. The Surgical Preparation scenario includes skill tags for Surgical Knowledge, Teamwork, and Attention to Detail, preparing trainees for the collaborative and precise nature of surgical environments. The Mental Health Consultation scenario features skill tags for Empathy, Patient Interaction, and Communication, recognizing the interpersonal sensitivity required when addressing psychological and emotional concerns with patients.

As illustrated in FIG. 11, the user interface 411 presents a scenario list tailored for law enforcement training, featuring seven distinct scenarios that address various situations encountered by law enforcement professionals. The scenarios are displayed in a card-like format within the user interface 411, with each card containing the scenario title and associated skill tags that identify the competencies to be developed through engagement with that particular simulation. The Barricaded Suspect Standoff scenario focuses on negotiating a peaceful surrender and includes skill tags for Negotiation, Patience, and Crisis Management. The Kidnapping Investigation scenario emphasizes gathering intelligence and making quick decisions, with skill tags for Investigation, Decision Making, and Situational Awareness. The Crowd Control During a Protest scenario addresses maintaining order and safety, featuring skill tags for Conflict Resolution, Communication, and Ethical Judgment. The decision tree algorithms employed by the processor 220 evaluate the skill tags and scenario parameters to generate appropriate simulated person responses based on the background data 620F and training data 430D stored within the database 115.

In another preferred embodiment, the law enforcement scenarios presented in FIG. 11 include additional training exercises that address complex operational situations requiring tactical thinking and interpersonal skills. The Undercover Drug Bust scenario focuses on gaining trust and staying covert, with skill tags for Deception Detection, Emotional Intelligence, and Adaptability. The Human Trafficking Rescue Operation scenario emphasizes coordinating with multiple agencies and includes skill tags for Teamwork, Empathy, and Decision Making. The Active Bank Robbery scenario addresses managing hostages and suspects, featuring skill tags for Tactical Thinking, Situational Awareness, and Negotiation. The School Threat Response scenario focuses on securing the area and communicating with the public, with skill tags for Crisis Management, Public Communication, and Decision Making. For instance, a law enforcement trainee selecting the Human Trafficking Rescue Operation scenario would engage with simulated persons whose background data 620F influences their demeanor and responses throughout the multi-agency coordination exercise. The system 400 tracks which scenarios each user 405 has completed and stores this information within the user profile 430 in the database 115 for subsequent review by instructors with appropriate permission levels 800.

In some preferred embodiments, the system 400 utilizes decision tree algorithms to correlate the skill tags associated with each scenario with the user data 430A stored within the user profile 430 to recommend appropriate training exercises. The decision tree algorithms traverse branching logic structures that evaluate the user's prior performance metrics, identified skill gaps, and professional development objectives to prioritize scenarios that address areas requiring additional practice. For instance, a trainee who has demonstrated difficulty with empathy-related metrics in prior simulated interactions 600 may be presented with scenarios such as Mental Health Consultation or Pediatric Diagnosis that emphasize empathetic communication skills. The processor 220 retrieves the skill tag data and user performance history from the database 115 via the server 110 and applies the decision tree algorithms to generate personalized scenario recommendations displayed through the user interface 411. The non-transitory computer-readable medium 416 coupled to the processor 220 contains instructions that govern how the decision tree algorithms evaluate skill tag correlations and generate recommendations based on the training data 430D associated with each user profile 430. This personalized approach ensures that welfare and safety personnel can engage with scenarios that are most relevant to their individual development needs while building competencies across both technical and interpersonal domains.

FIG. 12 illustrates a user interface within the virtual patient simulation system that allows users to select the difficulty level of a scenario. The interface presents three options: Easy, Medium, and Hard, enabling users to tailor the complexity of the simulation to their current skill level or training objectives. This feature provides flexibility in the learning process, allowing users to gradually increase the challenge as they become more proficient in handling virtual patient interactions. By offering adjustable difficulty levels, the system ensures that users can engage with scenarios that are appropriately challenging, promoting continuous skill development and confidence building in a controlled and supportive environment. This adaptability is crucial for accommodating a wide range of users, from novices to experienced professionals, ensuring that each user can maximize their learning experience according to their individual needs and progress.

FIGS. 13 and 14 depict user performance dashboards presented via the user interface 411 of the computing device 410, providing a comprehensive overview of individual progress and skill development for welfare and safety personnel engaged in training scenarios. In a preferred embodiment, each dashboard features a radar chart that visually represents key performance metrics stored within the training data 430D, such as communication, situational awareness, teamwork, stress management, and conflict resolution, with values plotted on a scale that allows for comparative analysis across competency areas. As illustrated in FIG. 13, the radar chart presents five performance axes arranged in a pentagonal configuration, enabling users 405 and instructors with appropriate permission levels 800 to quickly identify strengths and areas requiring additional practice. The decision tree algorithms employed by the processor 220 analyze the trainee's performance across multiple simulated interactions 600 to generate the aggregated scores displayed within the radar chart, with each metric derived from specific behavioral indicators observed during the training scenarios. In some preferred embodiments, the performance metrics may be weighted differently based on the professional domain of the trainee, such that medical professionals may have empathy and communication weighted more heavily while law enforcement professionals may have situational awareness and conflict resolution emphasized. The processor 220 retrieves the performance data from the database 115 via the server 110 and renders the radar chart through the display 316 via the display interface 316A, presenting the information in a format that facilitates rapid comprehension of the trainee's overall competency profile.

In another preferred embodiment, the dashboards depicted in FIGS. 13 and 14 include bar graphs illustrating the number of problems attempted over the last thirty days, categorized by difficulty levels including Easy, Medium, and Hard, allowing users 405 to track their engagement with the system 400 over time. As illustrated in FIG. 14, the bar graph displays daily activity data with vertical bars indicating the number of problems attempted each day, enabling instructors with administrator roles 870 to monitor trainee engagement and identify users 405 who may require additional encouragement or support. The decision tree algorithms process the historical interaction data stored within the user profile 430 to generate the bar graph visualization, aggregating completed scenarios by date and difficulty level to produce the displayed metrics. In some preferred embodiments, the dashboards also display performance scores for each difficulty level through semi-circular gauge meters, such as the scores of 40/50 for Easy, 24/40 for Medium, and 11/30 for Hard shown in FIG. 14, offering insights into the user's strengths and areas that may require further practice. The user profile section displayed on the left side of the dashboard includes identifying information such as the user's name, institutional affiliation, and professional specialty, which the processor 220 retrieves from the user data 430A stored within the database 115. By providing a detailed analysis of performance metrics and engagement patterns, these dashboards serve as valuable tools for users 405 to assess their progress, set training goals, and enhance their readiness for real-world interactions with persons of varying cultural and socioeconomic backgrounds in their respective professional fields.

FIG. 15 illustrates a user interface 411 within the system 400, designed for a scenario involving emergency dispatcher training that requires rapid information gathering and coordination of response resources. In a preferred embodiment, the interface is divided into multiple sections, each providing information and tools for effective scenario management and decision-making during simulated emergency calls. As illustrated in FIG. 15, the upper portion of the screen displays a data intake panel showing call information fields including call date, time, caller details, address information, and call type options, which the processor 220 populates based on the training data 430D associated with the selected scenario. The decision tree algorithms employed by the system 400 generate simulated caller communications based upon the background data 620F stored within the training data 430D, which may include the caller's emotional state, language proficiency, and the nature of the emergency being reported. In some preferred embodiments, a simulated caller reporting a medical emergency may speak rapidly and provide incomplete information, requiring the trainee to ask clarifying questions while maintaining a calm and reassuring tone as evaluated by the rapport score calculation. The data intake panel allows trainees to record information gathered during the simulated call, with the system 400 tracking which fields are completed and the accuracy of the recorded information as part of the training data associated with the user profile 430.

In another preferred embodiment, the user interface 411 depicted in FIG. 15 includes a map interface positioned in the central portion of the screen, providing geographical context with street names and landmarks that is relevant for location-based decision-making in emergency response scenarios. The map interface displays the reported location of the emergency along with nearby resources such as hospitals, fire stations, and police precincts, enabling the trainee to coordinate appropriate response units based on proximity and availability. As illustrated in FIG. 15, the right side of the interface displays a status panel indicating that a dispatch plan has been initiated, along with unit assignments showing different response teams and their current status within the simulated environment. The decision tree algorithms process the trainee's dispatch decisions and evaluate whether the selected units are appropriate for the type of emergency reported, adjusting the rapport score and performance metrics based on the efficiency and accuracy of the response coordination. In some preferred embodiments, the communication panel on the far right of the interface shows a simulated conversation between the dispatcher and a caller, with the dialogue generated by the machine learning techniques based on the training data 430D and the trainee's responses entered through the text input field. The interface also includes a time remaining indicator and a submit assignment button, suggesting an evaluation component to the training exercise that the processor 220 uses to calculate final performance scores stored within the user profile 430 in the database 115.

In a preferred embodiment, the emergency dispatcher scenario depicted in FIG. 15 incorporates function buttons labeled F1 through F12 along with status indicators for various dispatch operations, simulating the keyboard shortcuts and interface elements commonly used in real-world emergency dispatch centers. The decision tree algorithms evaluate the trainee's use of these function buttons and status indicators to determine whether proper protocols are being followed during the simulated emergency response. For instance, a trainee who fails to update the status of dispatched units or neglects to record relevant remarks in the appropriate fields may receive a lower performance score reflecting procedural deficiencies. In another preferred embodiment, the system 400 may present scenarios involving language barriers, wherein the simulated caller has limited proficiency in the trainee's language as indicated by the background data 620F, and the trainee must adapt their communication approach accordingly to gather necessary information. The processor 220 retrieves the scenario parameters from the database 115 via the server 110 and applies the decision tree algorithms to generate caller responses that reflect the specified language proficiency level and emotional state. This comprehensive layout ensures that trainees have access to all necessary information and controls within the user interface 411, allowing them to make informed decisions and effectively manage the scenario while developing both technical competencies and interpersonal skills necessary for effective performance in emergency dispatch contexts.

FIG. 16 illustrates a user interface 411 within the system 400, specifically designed for a scenario involving a driver pullover in a law enforcement training context. As illustrated in FIG. 16, the left side of the screen displays a detailed visual representation of the scene, featuring a police officer approaching a vehicle and interacting with the driver through a grayscale rendering that depicts the officer holding a flashlight while approaching the driver's side of the car. The processor 220 operably connected to the computing device 410 retrieves the training data 430D from the database 115 via the server 110 and renders the scenario environment through the display 316 via the display interface 316A. The visual component is rendered with attention to environmental elements such as lighting conditions and road settings, which contribute to the authenticity of the simulation and allow users 405 to observe and assess the situation as it unfolds. In a preferred embodiment, the image data 430B stored within the database 115 provides the visual assets necessary to construct the traffic stop environment, including vehicle models, officer avatars, and background scenery. The decision tree algorithms employed by the system 400 process the avatar data 430C to determine how the simulated driver responds to the trainee's approach and initial communication, with behavioral parameters governing the driver's demeanor based on the background data 620F associated with the scenario.

In another preferred embodiment, the right side of the user interface 411 includes a dialogue panel where the conversation between the officer and the driver is presented, with alternating messages displayed in different shading to distinguish between the two parties. As illustrated in FIG. 16, the dialogue exchange shows the officer explaining the reason for the stop, the driver's response about the traffic light, and requests for documentation, demonstrating the interactive nature of the simulated interaction. Users 405 can engage with the scenario by selecting or inputting responses through the text input field labeled “Enter your question,” which are then processed by the decision tree algorithms to generate contextually appropriate simulated driver communications based on the training data 430D. The decision tree algorithms traverse branching logic structures that evaluate the trainee's communication style, tone, and content to determine whether the simulated driver becomes more cooperative or more defensive throughout the interaction. For instance, a trainee who approaches the simulated driver with a calm and professional demeanor may observe the driver's anxiety decrease over time, while a trainee who uses aggressive or dismissive language may trigger escalating tension in the simulated responses. The dialogue options are crafted to reflect realistic conversational dynamics, offering users 405 the opportunity to practice de-escalation techniques, assertiveness, and empathy as evaluated by the rapport score calculation performed by the processor 220.

In some preferred embodiments, the user interface 411 provides options for users 405 to request and review documents such as the driver's license, insurance, and car registration, simulating real-world procedures during a traffic stop. As illustrated in FIG. 16, three document icons are displayed below the visual panels representing these documents that can be accessed during the scenario, with the processor 220 retrieving the corresponding discoverable data 620E from the database 115 when the trainee requests each document. The decision tree algorithms evaluate whether the trainee has established sufficient rapport with the simulated driver before granting access to certain discoverable data 620E, reflecting how real drivers may be more or less forthcoming with documentation depending on their comfort level with the officer. For instance, a simulated driver whose background data 620F indicates prior negative experiences with law enforcement may initially refuse to provide documentation until the trainee demonstrates patience and professionalism through their communications. The system 400 records all document requests and the sequence in which they are made as part of the training data associated with the user profile 430, enabling instructors with appropriate permission levels 800 to review whether the trainee followed proper procedural protocols. These document interactions are designed to mimic actual law enforcement protocols, requiring users 405 to verify information and make decisions based on the data provided while maintaining appropriate communication with the simulated driver.

In a preferred embodiment, the user interface 411 includes feedback mechanisms that evaluate the user's performance, offering insights into areas such as compliance with standard operating procedures, effectiveness in communication, and overall interaction quality as stored within the training data 430D. The decision tree algorithms analyze the trainee's actions throughout the simulated interaction 600 and calculate adjustments to the rapport score based on the appropriateness of each communication and procedural step taken during the traffic stop scenario. As illustrated in FIG. 16, a timer showing “Time Remaining: 29:48” appears in the lower left corner of the interface, indicating the timed nature of the training exercise and adding pressure that simulates real-world time constraints faced by law enforcement professionals. The processor 220 retrieves the performance metrics from the database 115 and presents them through the user interface 411 upon completion of the scenario, allowing the trainee to review their strengths and areas requiring additional practice. In another preferred embodiment, the system 400 may simulate various outcomes based on user choices, with the decision tree algorithms determining whether the interaction concludes with a warning, a citation, or an escalation requiring additional intervention. This comprehensive approach ensures that users 405 not only practice procedural tasks but also refine their interpersonal skills, preparing them for real-world law enforcement scenarios where clear communication and procedural adherence are essential for successful outcomes.

In some preferred embodiments, the scenario depicted in FIG. 16 involving a driver pullover may be carried out in a virtual reality setting with an enhanced level of immersion and realism through peripheral devices 270 operably connected to the computing device 410. Users 405 would don virtual reality headsets and possibly other haptic feedback devices connected via the communication interface 280 to fully engage with the simulated environment rendered by the processor 220. The virtual reality system would create a 360-degree, three-dimensional representation of the traffic stop scene using the image data 430B and avatar data 430C stored within the database 115, allowing users 405 to physically move around and interact with the environment as if they were actually present at the location. As the police officer, users 405 could approach the virtual vehicle, observe the surroundings, and interact with the driver in a lifelike manner, with the decision tree algorithms processing their movements and communications to generate appropriate simulated driver responses. The virtual reality environment would simulate realistic environmental conditions such as varying weather, time of day, and traffic noise, with these parameters stored within the training data 430D and retrieved by the processor 220 to enhance the authenticity of the experience. In another preferred embodiment, users 405 would be able to use hand gestures or voice commands captured by peripheral devices 270 to communicate with the virtual driver, request documents, and perform other procedural tasks, all of which would be tracked and responded to by the decision tree algorithms in real-time.

In a preferred embodiment, the dialogue with the simulated driver in the virtual reality setting would be conducted through natural language processing techniques integrated with the decision tree algorithms, allowing users 405 to speak directly to the virtual character and receive responses that reflect realistic conversational dynamics based on the background data 620F. The processor 220 would analyze the spoken input captured by the audio codec 360 of the mobile computing device 350 or similar peripheral device 270 and apply the decision tree algorithms to generate contextually appropriate simulated driver communications. This interaction would help users 405 practice essential skills such as de-escalation, assertiveness, and empathy in a more intuitive and engaging way than traditional text-based interfaces presented through the user interface 411. For instance, a trainee who speaks in a calm and measured tone may observe the virtual driver's body language relax, while a trainee who raises their voice may trigger defensive posturing in the avatar rendered using the avatar data 430C. Feedback mechanisms within the virtual reality system would provide immediate insights into the user's performance through the display 316, highlighting areas such as adherence to standard operating procedures, communication effectiveness, and overall interaction quality as calculated by the decision tree algorithms. The virtual reality system could simulate various outcomes based on user choices stored within the training data 430D, offering a dynamic and adaptive training experience that encourages strategic decision-making and prepares law enforcement professionals for the complexities of real-world traffic stop interactions with persons of varying cultural and socioeconomic backgrounds.

FIG. 17 illustrates a user interface 411 within the system 400, specifically designed for a scenario involving pregnancy counseling in a medical training context. As illustrated in FIG. 17, the left side of the screen displays a three-dimensional rendering of a counseling room environment that includes a bed, a table with chairs, and a digital clock, with the image data 430B stored within the database 115 providing the visual assets necessary to construct this clinical setting. A virtual patient avatar stands in the center of the room, representing a pregnant woman who has come to discuss her pregnancy with a healthcare provider, with the avatar rendered using the avatar data 430C and image data 430B retrieved by the processor 220 from the database 115 via the server 110. The processor 220 operably connected to the computing device 410 executes instructions stored on the non-transitory computer-readable medium 416 to render the scenario environment through the display 316 via the display interface 316A. In a preferred embodiment, the decision tree algorithms employed by the system 400 process the avatar data 430C to determine how the simulated patient responds to the trainee's communications, with behavioral parameters governing the patient's demeanor based on the background data 620F associated with the scenario. The visual environment is designed to provide trainees with contextual cues that inform their approach to the counseling session, such as the patient's body language and positioning within the room.

In another preferred embodiment, the right side of the user interface 411 features a dialogue panel where the conversation between the counselor and the patient is presented, with alternating messages displayed to distinguish between the two parties engaged in the simulated interaction 600. As illustrated in FIG. 17, the dialogue exchange shows patient statements about wanting to discuss her pregnancy, experiencing intermittent nausea and occasional vomiting, along with highlighted response options from the trainee such as inquiries about what brings the patient in and whether she is experiencing any symptoms. The decision tree algorithms traverse branching logic structures that evaluate the trainee's communication style, tone, and content to determine whether the simulated patient becomes more forthcoming or more guarded throughout the interaction based on the background data 620F. For instance, a trainee who approaches the simulated patient with empathy and uses open-ended questions may observe the patient sharing additional concerns about her pregnancy, while a trainee who uses clinical terminology without explanation may trigger hesitancy in the simulated responses. In some preferred embodiments, the decision tree algorithms may incorporate threshold-based logic wherein the simulated patient's willingness to disclose sensitive information about her pregnancy is contingent upon the trainee achieving a minimum rapport score during the interaction. The text input field at the bottom of the interface allows trainees to enter questions or responses that are processed by the decision tree algorithms to generate contextually appropriate simulated patient communications 615A.

In a preferred embodiment, the user interface 411 depicted in FIG. 17 includes a series of icons below the main viewing area representing available diagnostic tools or actions including blood test, ultrasound, medical history, urine test, and immunization options that the trainee may access during the counseling session. The processor 220 retrieves the corresponding discoverable data 620E from the database 115 when the trainee requests each diagnostic option, with the decision tree algorithms evaluating whether the trainee has established sufficient rapport with the simulated patient before granting access to certain sensitive information. For instance, a simulated patient whose background data 620F indicates cultural or religious beliefs that influence her views on certain medical procedures may initially decline specific tests until the trainee demonstrates understanding and respect for her perspective through their communications. In some preferred embodiments, the training data 430D associated with the pregnancy counseling scenario may include discoverable data 620E such as prior pregnancy history, family medical history, or personal circumstances that the simulated patient will only share if the rapport score exceeds a specified threshold. The system 400 records all diagnostic requests and the sequence in which they are made as part of the training data associated with the user profile 430, enabling instructors with appropriate permission levels 800 to review whether the trainee followed proper clinical protocols while maintaining sensitivity to the patient's emotional state. The interface header indicates the assignment level and term designation, while a timer in the lower left corner shows the remaining time for the assignment and a submit assignment button appears in the lower right corner of the screen.

In another preferred embodiment, the pregnancy counseling scenario depicted in FIG. 17 is designed to develop skills such as empathy, active listening, and effective communication that are essential in providing supportive and informative counseling to patients facing sensitive medical situations. The decision tree algorithms analyze the trainee's responses and calculate adjustments to the rapport score based on the appropriateness of each communication, with the adjustment magnitude and direction determined by the combination of the trainee's action and the simulated patient's background characteristics stored within the background data 620F. As illustrated in FIG. 4, the processor 220 operably connected to the computing device 410 retrieves the current rapport score from the training data 430D stored within the database 115 and applies the decision tree algorithms to determine how the simulated patient responds to the trainee's inquiries about her pregnancy. In some preferred embodiments, the background data 620F may indicate characteristics such as the simulated patient's age, marital status, cultural background, and prior experiences with healthcare providers that influence how she communicates and responds to the trainee's questions. For instance, a simulated patient whose background data 620F indicates she is an unmarried teenager from a conservative family may exhibit heightened anxiety and require additional reassurance before discussing her pregnancy openly with the trainee. The system 400 stores all performance analytics within the database 115 operably connected to the server 110, ensuring that instructors with administrator roles 870 may access comprehensive records of trainee performance across multiple pregnancy counseling scenarios to identify patterns and areas requiring additional practice.

FIG. 18 illustrates a user interface 411 within the system 400, designed for a scenario involving an interrogation setting for law enforcement training purposes. As illustrated in FIG. 18, the left side of the screen displays a visual representation of an interrogation room environment featuring a person in light-colored clothing standing in a tiled room with scattered papers on the floor and a door visible in the background, with the image data 430B stored within the database 115 providing the visual assets necessary to construct this investigative setting. The processor 220 operably connected to the computing device 410 retrieves the training data 430D from the database 115 via the server 110 and renders the scenario environment through the display 316 via the display interface 316A. In a preferred embodiment, the decision tree algorithms employed by the system 400 process the avatar data 430C to determine how the simulated subject responds to the trainee's communications, with behavioral parameters governing the subject's demeanor based on the background data 620F associated with the scenario. The visual environment is designed to provide trainees with contextual cues that inform their approach to the interrogation, such as the subject's body language, the state of the room, and environmental details that may indicate the subject's emotional state or level of cooperation. For instance, a simulated subject whose background data 620F indicates prior experience with law enforcement interrogations may exhibit more guarded body language and provide shorter, more evasive responses compared to a subject with no prior exposure to such situations.

In another preferred embodiment, the right side of the user interface 411 features a dialogue panel where the conversation between the interrogator and the subject is presented, with alternating messages displayed to distinguish between the two parties engaged in the simulated interaction 600. As illustrated in FIG. 18, the dialogue exchange shows subject statements such as “I already told you, I don't know anything!” and “That's impossible. Someone must have set me up!” along with interrogator questions about the subject's whereabouts and evidence placing them at a crime scene, demonstrating the interactive nature of the simulated interrogation. The decision tree algorithms traverse branching logic structures that evaluate the trainee's communication style, tone, and content to determine whether the simulated subject becomes more cooperative or more defensive throughout the interaction based on the background data 620F. In some preferred embodiments, the decision tree algorithms may implement threshold-based logic wherein the simulated subject's willingness to provide information is contingent upon the trainee achieving a minimum rapport score during the interaction. For instance, a trainee who approaches the simulated subject with aggressive or accusatory language may observe the subject becoming increasingly uncooperative, while a trainee who employs rapport-building techniques may gradually elicit more detailed responses from the subject. The text input field labeled “Enter your question” at the bottom of the interface allows trainees to enter questions or statements that are processed by the decision tree algorithms to generate contextually appropriate simulated subject communications based on the training data 430D.

In a preferred embodiment, the user interface 411 depicted in FIG. 18 includes three icons positioned below the visual representation, labeled ID, History, and DNA Evidence, representing available documents or evidence that the trainee may access during the interrogation scenario. The processor 220 retrieves the corresponding discoverable data 620E from the database 115 when the trainee requests each evidence item, with the decision tree algorithms evaluating whether the trainee has established sufficient rapport with the simulated subject before granting access to certain sensitive information or determining how the subject reacts to the presentation of evidence. In some preferred embodiments, the decision tree algorithms may determine that presenting evidence prematurely, before establishing rapport, causes the simulated subject to become more defensive or to request legal representation, thereby limiting the trainee's ability to gather additional information. For instance, a trainee who presents DNA evidence without first building rapport may trigger a response from the simulated subject demanding an attorney, effectively ending the productive portion of the interrogation. The system 400 records all evidence access requests and the sequence in which they are made as part of the training data associated with the user profile 430, enabling instructors with appropriate permission levels 800 to review whether the trainee followed proper investigative protocols. The timer showing “Time Remaining: 29:40” in the lower left corner of the interface indicates the timed nature of the training exercise, adding pressure that simulates real-world time constraints faced by law enforcement professionals during interrogations.

In another preferred embodiment, the interrogation scenario depicted in FIG. 18 is designed to develop skills such as communication, situational awareness, and decision-making under pressure that are essential for law enforcement professionals conducting investigative interviews. The decision tree algorithms analyze the trainee's responses and calculate adjustments to the rapport score based on the appropriateness of each communication, with the adjustment magnitude and direction determined by the combination of the trainee's action and the simulated subject's background characteristics stored within the background data 620F. As illustrated in FIG. 4, the processor 220 operably connected to the computing device 410 retrieves the current rapport score from the training data 430D stored within the database 115 and applies the decision tree algorithms to determine how the simulated subject responds to the trainee's inquiries about the alleged crime. In some preferred embodiments, the background data 620F may indicate characteristics such as the simulated subject's prior criminal history, psychological profile, cultural background, and relationship to the alleged crime that influence how they communicate and respond to the trainee's questions. For instance, a simulated subject whose background data 620F indicates a history of false accusations may exhibit heightened defensiveness and require additional reassurance before providing any information, while a subject with no prior criminal involvement may be more forthcoming once they understand the nature of the investigation. The system 400 stores all performance analytics within the database 115 operably connected to the server 110, ensuring that instructors with administrator roles 870 may access comprehensive records of trainee performance across multiple interrogation scenarios to identify patterns and areas requiring additional practice in investigative interviewing techniques.

FIG. 19 illustrates a user interface 411 within the system 400, specifically designed for a scenario focused on interview training for human resources and recruiters. As illustrated in FIG. 19, the interface displays a desktop computer setup including a monitor, keyboard, mouse, and computer tower positioned on a desk surface, with the monitor screen showing a virtual candidate avatar on the left side depicting a professional woman in business attire. The processor 220 operably connected to the computing device 410 retrieves the training data 430D from the database 115 via the server 110 and renders the scenario environment through the display 316 via the display interface 316A. In a preferred embodiment, the decision tree algorithms employed by the system 400 process the avatar data 430C to determine how the simulated candidate responds to the trainee's communications, with behavioral parameters governing the candidate's demeanor based on the background data 620F associated with the scenario. The right side of the user interface 411 features a dialogue panel presenting the conversation between the interviewer and the candidate, with multiple folder icons visible below the avatar representing accessible documents or candidate profiles. A text input field and submit button are positioned at the bottom of the interface, allowing users 405 to engage with the scenario by inputting responses that are then processed by the decision tree algorithms to generate contextually appropriate simulated candidate communications based on the training data 430D.

In another preferred embodiment, the user interface 411 depicted in FIG. 19 includes options for users 405 to access and review relevant documents or candidate profiles through the folder icons, simulating real-world procedures in the recruitment process. The processor 220 retrieves the corresponding discoverable data 620E from the database 115 when the trainee requests each document, with the decision tree algorithms evaluating whether the trainee has asked appropriate preliminary questions before accessing certain candidate information. For instance, a trainee who immediately accesses a candidate's salary history without first establishing rapport or discussing the role may receive a lower performance score reflecting procedural deficiencies in interview protocol. The decision tree algorithms traverse branching logic structures that evaluate the trainee's communication style, tone, and content to determine whether the simulated candidate becomes more forthcoming or more guarded throughout the interaction based on the background data 620F. In some preferred embodiments, the background data 620F may indicate characteristics such as the simulated candidate's prior interview experiences, cultural background, and professional expectations that influence how they communicate and respond to the trainee's questions. The system 400 records all document access requests and the sequence in which they are made as part of the training data associated with the user profile 430, enabling instructors with appropriate permission levels 800 to review whether the trainee followed proper human resources protocols during the simulated interview.

In a preferred embodiment, the interview training scenario depicted in FIG. 19 is designed to develop skills such as effective communication, active listening, and decision-making that are relevant for conducting professional interviews in human resources contexts. The decision tree algorithms analyze the trainee's responses and calculate adjustments to the rapport score based on the appropriateness of each communication, with the adjustment magnitude and direction determined by the combination of the trainee's action and the simulated candidate's background characteristics stored within the background data 620F. As illustrated in FIG. 4, the processor 220 operably connected to the computing device 410 retrieves the current rapport score from the training data 430D stored within the database 115 and applies the decision tree algorithms to determine how the simulated candidate responds to the trainee's inquiries about their qualifications and experience. For instance, a trainee who asks open-ended questions and demonstrates genuine interest in the candidate's career goals may observe the simulated candidate sharing additional information about their motivations and aspirations, while a trainee who uses overly formal or dismissive language may trigger hesitancy in the simulated responses. In some preferred embodiments, the decision tree algorithms may implement threshold-based logic wherein the simulated candidate's willingness to disclose information about salary expectations or reasons for leaving previous employment is contingent upon the trainee achieving a minimum rapport score during the interaction. The system 400 stores all performance analytics within the database 115 operably connected to the server 110, ensuring that instructors with administrator roles 870 may access comprehensive records of trainee performance across multiple interview scenarios to identify patterns and areas requiring additional practice in recruitment interviewing techniques.

In another preferred embodiment, the system 400 may be configured to train academic advisors and professors on how to advise students by simulating a variety of advising scenarios that reflect the diverse challenges and situations encountered in educational settings. The decision tree algorithms generate simulated student communications based upon the background data 620F stored within the training data 430D, which may include the student's academic standing, generational cohort, cultural background, and personal circumstances affecting their studies. For instance, a simulated student whose background data 620F indicates membership in Generation Z may exhibit preferences for digital communication and instant feedback, while a simulated student from an earlier generational cohort may express different expectations regarding advisor availability and communication methods. The processor 220 retrieves the scenario parameters from the database 115 via the server 110 and applies the decision tree algorithms to generate student responses that reflect the specified generational characteristics and academic concerns. In some preferred embodiments, the system 400 may simulate interactions with students experiencing academic difficulties, uncertainty about career paths, or personal challenges impacting their studies, requiring the trainee to demonstrate empathy, active listening, and culturally sensitive communication. The decision tree algorithms evaluate the trainee's responses and adjust the rapport score based on whether the communication approach aligns with the simulated student's expectations and needs as defined within the background data 620F.

In a preferred embodiment, the academic advising scenarios may incorporate generational-specific concerns that influence how simulated students communicate and respond to advisor guidance. The background data 620F may indicate characteristics such as the simulated student's attitudes toward social media, sustainability, work-life balance, or career advancement opportunities that affect their academic and professional decision-making processes. For instance, a simulated student whose background data 620F indicates strong concerns about environmental sustainability may respond more positively to career guidance that incorporates discussion of socially responsible employers or green industry opportunities. The decision tree algorithms traverse branching logic structures that evaluate the trainee's communication content to determine whether the advisor has acknowledged and addressed the student's generational values and motivations. In another preferred embodiment, the system 400 may track and evaluate the professor's performance across multiple advising sessions stored within the user profile 430, offering insights into areas such as communication effectiveness, problem-solving skills, and adherence to advising protocols established by the educational institution. The non-transitory computer-readable medium 416 coupled to the processor 220 contains instructions that govern how the decision tree algorithms evaluate generational awareness indicators and calculate corresponding adjustments to the rapport score based on the trainee's demonstrated understanding of diverse student populations.

FIG. 20 illustrates a user interface 411 within the system 400, showcasing the process of creating and manipulating virtual avatars for use in various training scenarios presented via the display 316. As illustrated in FIG. 20, the interface is divided into three main sections displayed side by side, each serving a distinct function in the avatar creation and manipulation workflow. On the left side, a three-dimensional model of a virtual avatar is displayed in a standing pose with arms extended outward, allowing users 405 to view and adjust the avatar's physical attributes such as posture, body orientation, and overall positioning within the simulated environment. The processor 220 operably connected to the computing device 410 retrieves the image data 430B and avatar data 430C from the database 115 via the server 110 to render the three-dimensional avatar model through the display interface 316A. In a preferred embodiment, this section provides tools for customizing the avatar's appearance to reflect diverse patient demographics stored within the background data 620F, enhancing the realism and applicability of the training scenarios across medical, law enforcement, and emergency response contexts. The decision tree algorithms employed by the system 400 process the avatar data 430C to determine appropriate physical characteristics based on the demographic parameters specified within the training data 430D.

In another preferred embodiment, the center section of the user interface 411 depicted in FIG. 20 displays a skeletal framework that demonstrates the underlying bone and joint structure used to animate the avatar during simulated interactions 600. The skeletal framework shows the hierarchical arrangement of joints from head to feet, with visible connection points at major articulation areas including shoulders, elbows, hips, and knees. This framework is utilized for ensuring that the avatar's movements are fluid and lifelike, contributing to the authenticity of the simulation experience presented via the display 316. The processor 220 executes instructions stored on the non-transitory computer-readable medium 416 to coordinate the skeletal animation with the avatar data 430C, enabling realistic body language and physical responses during training scenarios. For instance, a simulated patient avatar may exhibit subtle shifts in posture or hand movements that indicate discomfort or anxiety, prompting trainees to adjust their communication approach accordingly. The decision tree algorithms traverse branching logic structures that correlate specific emotional states defined within the avatar data 430C with corresponding skeletal animations, ensuring that the avatar's physical presentation aligns with the behavioral parameters governing the simulated person's demeanor.

In some preferred embodiments, the right side of the user interface 411 depicted in FIG. 20 displays a real-world reference image showing a person standing in a similar pose with a skeletal overlay superimposed on their body, demonstrating how the system 400 captures and translates human movement data into the virtual avatar model. This reference section illustrates the motion capture or pose estimation process that informs the avatar's animation capabilities stored within the avatar data 430C. The processor 220 retrieves the reference data from the database 115 and applies the decision tree algorithms to map human movement patterns onto the skeletal framework of the virtual avatar. The system 400 may utilize peripheral devices 270 such as cameras operably connected to the computing device 410 via the communication interface 280 to capture real-time movement data that enhances the avatar's behavioral repertoire. For instance, motion capture data from healthcare professionals demonstrating proper bedside manner may be incorporated into the avatar data 430C to enable simulated patients to exhibit realistic responses to trainee actions. The decision tree algorithms evaluate the captured movement data and determine appropriate animation sequences based on the emotional state indicators and personality traits defined within the training data 430D.

In a preferred embodiment, the user interface 411 depicted in FIG. 20 includes options for users 405 to adjust the avatar's animations, enabling them to simulate various physical conditions or emotional states that a simulated person might exhibit during an interaction with welfare and safety personnel. The decision tree algorithms process the animation parameters in conjunction with the background data 620F to generate contextually appropriate physical behaviors that reflect the simulated person's cultural background and personal characteristics. For instance, an avatar representing a patient from a cultural background where direct eye contact with authority figures is considered disrespectful may be configured to exhibit averted gaze patterns during the simulated interaction 600. The processor 220 retrieves the animation configuration data from the database 115 via the server 110 and applies the decision tree algorithms to select appropriate movement sequences based on the scenario parameters stored within the training data 430D. In another preferred embodiment, administrators 865 with appropriate permission levels 800 may modify the avatar animation settings to create customized training scenarios that target specific interpersonal challenges identified through analysis of trainee performance data. The non-transitory computer-readable medium 416 coupled to the processor 220 contains instructions that govern how the decision tree algorithms correlate animation parameters with the background data 620F to produce culturally authentic avatar behaviors.

In some preferred embodiments, the avatars depicted in FIG. 20 are generated automatically by the system 400 via decision tree algorithms that process demographic parameters and physical characteristic specifications stored within the training data 430D. The system 400 draws from a comprehensive database 115 of image data 430B and demographic information contained within the background data 620F to create avatars that accurately reflect a wide range of physical characteristics and cultural backgrounds. The automated generation process begins with the decision tree algorithms selecting key attributes such as age, gender, ethnicity, and body type based on the scenario parameters defined within the training data 430D. The processor 220 operably connected to the computing device 410 executes the decision tree algorithms stored on the non-transitory computer-readable medium 416 to construct a three-dimensional model of the avatar using the selected attributes. For instance, a training scenario focused on geriatric care may trigger the decision tree algorithms to generate an avatar with physical characteristics appropriate for an elderly patient, including posture adjustments and movement limitations consistent with advanced age. The decision tree algorithms traverse branching logic structures that evaluate the demographic parameters and select corresponding visual assets from the image data 430B to assemble the avatar model.

In a preferred embodiment, once the basic avatar structure is established, the system 400 enhances the avatar by incorporating dynamic elements such as facial expressions and body movements that are generated using the decision tree algorithms in conjunction with the avatar data 430C. The decision tree algorithms evaluate the emotional state indicators defined within the training data 430D and select appropriate facial expression configurations and body movement sequences from the animation library stored within the database 115. These dynamic elements allow the avatars to exhibit lifelike behaviors and emotions during simulated interactions 600, contributing to the authenticity of the training experience presented via the user interface 411. The processor 220 coordinates the retrieval of animation data from the database 115 via the server 110 and applies the decision tree algorithms to synchronize facial expressions with the simulated communications 615A generated during the interaction. For instance, a simulated patient who becomes anxious during a medical examination may exhibit facial expressions indicating discomfort along with body language such as crossed arms or fidgeting that the trainee must recognize and address through appropriate communication. The decision tree algorithms implement threshold-based logic wherein the intensity of emotional expressions correlates with the current rapport score, such that a simulated person with low rapport may exhibit more pronounced negative expressions compared to one with whom the trainee has established trust.

In another preferred embodiment, the system 400 utilizes the decision tree algorithms to ensure that each avatar's appearance captures nuances in facial features, skin tone, and body proportions that reflect the demographic characteristics specified within the background data 620F. The decision tree algorithms traverse branching logic structures that evaluate multiple demographic variables simultaneously to select appropriate visual components from the image data 430B stored within the database 115. The processor 220 executes the decision tree algorithms to assemble these visual components into a cohesive avatar model that accurately represents the intended demographic profile of the simulated person. For instance, a simulated patient whose background data 620F indicates South Asian ethnicity and middle age may be rendered with appropriate skin tone, facial structure, and body proportions that reflect these characteristics. The system 400 stores the generated avatar configurations within the avatar data 430C associated with each training scenario, allowing the same avatar to be consistently rendered across multiple training sessions conducted by different trainees. The automated avatar generation process ensures consistency and accuracy across simulations stored within the database 115, enabling instructors with administrator roles 870 to compare trainee performance across standardized scenarios featuring identical simulated person presentations.

In some preferred embodiments, the automated avatar generation capabilities of the system 400 streamline the creation of training scenarios while ensuring that users 405 can engage with a variety of simulated interactions 600 that mirror real-world diversity across medical, law enforcement, and emergency response contexts. The decision tree algorithms process the scenario parameters stored within the training data 430D to determine appropriate avatar configurations without requiring manual intervention from administrators 865. The processor 220 retrieves the demographic specifications from the database 115 via the server 110 and applies the decision tree algorithms to generate avatars that align with the cultural sensitivity training objectives of each scenario. For instance, a law enforcement training program focused on community relations may utilize the automated generation capabilities to create a diverse array of simulated persons representing various ethnic backgrounds, age groups, and socioeconomic circumstances encountered in patrol duties. The system 400 maintains version control of generated avatars within the database 115, allowing administrators with appropriate permission levels 800 to review and approve avatar configurations before deployment in formal training programs. This automated avatar generation process provides a rich and immersive training experience that enables welfare and safety personnel to develop a deeper understanding of cultural sensitivity and interpersonal communication through repeated interactions with realistically diverse simulated persons.

The subject matter described herein may be embodied in systems, apparatuses, methods, and/or articles depending on the desired configuration. In particular, various implementations of the subject matter described herein may be realized in digital electronic circuitry, integrated circuitry, specially designed application specific integrated circuits (ASICs), computer hardware, firmware, software, and/or combinations thereof. These various implementations may include implementation in one or more computer programs that may be executable and/or interpretable on a programmable system including at least one programmable processor, which may be special or general purpose, coupled to receive data and instructions from, and to transmit data and instructions to, a storage system, and at least one peripheral device.

These computer programs, which may also be referred to as programs, software, applications, software applications, components, or code, may include machine instructions for a programmable processor, and may be implemented in a high-level procedural and/or object-oriented programming language, and/or in assembly machine language. As used herein, the term “non-transitory computer-readable medium” refers to any computer program, product, apparatus, and/or device, such as magnetic discs, optical disks, memory, and Programmable Logic Devices (PLDs), used to provide machine instructions and/or data to a programmable processor, including a non-transitory computer-readable medium that receives machine instructions as a computer-readable signal. The term “computer-readable signal” refers to any signal used to provide machine instructions and/or data to a programmable processor. To provide for interaction with a user, the subject matter described herein may be implemented on a computer having a display device, such as a cathode ray tube (CRD), liquid crystal display (LCD), light emitting display (LED) monitor for displaying information to the user and a keyboard and a pointing device, such as a mouse or a trackball, by which the user may provide input to the computer. Displays may include, but are not limited to, visual, auditory, cutaneous, kinesthetic, olfactory, and gustatory displays, or any combination thereof.

Other kinds of devices may be used to facilitate interaction with a user as well. For instance, feedback provided to the user may be any form of sensory feedback, such as visual feedback, auditory feedback, or tactile feedback; and input from the user may be received in any form including, but not limited to, acoustic, speech, or tactile input. The subject matter described herein may be implemented in a computing system that includes a back-end component, such as a data server, or that includes a middleware component, such as an application server, or that includes a front-end component, such as a client computer having a graphical user interface or a Web browser through which a user may interact with the system described herein, or any combination of such back-end, middleware, or front-end components. The components of the system may be interconnected by any form or medium of digital data communication, such as a communication network. Examples of communication networks may include, but are not limited to, a local area network (“LAN”), a wide area network (“WAN”), metropolitan area networks (“MAN”), and the internet.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For instance, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, devices, and arrangements of the parts and method stages which have been described and illustrated in order to explain the nature of this inventive subject matter can be made without departing from the principles and scope of the inventive subject matter.

What we claim is:

1. A system for training welfare and safety personnel, comprising:
a computing device having a user interface,
wherein a user accesses a user profile via said user interface,
one or more displays operably connected to said computing device,
wherein said one or more displays are configured to present said user interface;
a processor operably connected to said computing device;
one or more of a server and a database operably connected to said processor,
wherein data relating to said user profile is stored therein,
wherein said data relating to said user profile is retrievable via instructions relayed through said user interface of said computing device,
wherein said data can be altered via instructions relayed through said user interface of said computing device;
a non-transitory computer-readable medium coupled to said processor,
wherein said non-transitory computer-readable medium contains instructions stored thereon, which, when executed by said processor, cause said processor to perform operations comprising:
determining an identity of said user accessing said user profile via said user interface,
retrieving said user profile having user data that pertains to said identity,
retrieving data pertaining to a simulated person from said one or more of a server and a database,
wherein said data pertaining to a simulated person comprises a person's name,
wherein said data pertaining to a simulated person further comprises a scenario identifier,
wherein said data pertaining to a simulated person further comprises discoverable data about said simulated person,
wherein said data pertaining to a simulated person further comprises background data about said simulated person,
generating, via a machine learning technique, simulated communications to mimic an interaction between welfare and safety personnel and said simulated person,
wherein said user simulates the role of a welfare and safety personnel in said interaction,
wherein said simulated communications are based upon said data pertaining to said simulated person,
wherein said simulated communications are based upon said user data of said user,
analyzing, via a machine learning technique, responses generated by said user to said simulated communications,
wherein said responses comprise text input via said user interface,
wherein said responses are necessary to access said discoverable data of said simulated person,
generating, via a machine learning technique, a quantifiable score that reflects rapport between said welfare and safety personnel and said simulated person,
adjusting, via a machine learning technique, said score higher or lower in response to actions taken by said user,
wherein said actions comprise said responses generated by said user,
wherein the conditions for adjusting said score are affected by said background data of said simulated person,
recording said interaction as training data associated with said user profile,
wherein said training data comprises all of said simulated communications and all of said responses,
wherein said training data comprises all of said changes to said score.

2. The system of claim 1, wherein said computing device records a permission level of said user profile, wherein said permission level instructs said computing device as to which content said user has permission to access via said user interface.

3. The system of claim 2, wherein said non-transitory computer-readable medium contains additional instructions stored thereon, which, when executed by said processor, cause said processor to perform further operations comprising:
retrieving said permission level of said user profile, and
determining to which of said content said user has access based on said permission level.

4. The system of claim 1, wherein said welfare and safety personnel are medical professionals.

5. The system of claim 4, wherein said simulated person is a simulated patient.

6. The system of claim 5, wherein said data pertaining to a simulated patient further comprises patient vital signs, wherein said data pertaining to a simulated patient further comprises patient complaints.

7. The system of claim 5, wherein said simulated communications mimic a patient in a patient-clinician interaction.

8. The system of claim 1, wherein said score is based on said background data of said simulated person, wherein said score is based on said user data of said user, wherein an amount of said discoverable data is only accessible via said user responses if said interaction possesses a minimum value of said score.

9. The system of claim 1, wherein said welfare and safety personnel are law enforcement professionals.

10. A method for training welfare and safety personnel, comprising the steps of:
determining an identity of a user accessing a user profile via a user interface,
retrieving said user profile having user data that pertains to said identity,
retrieving data pertaining to a simulated person from one or more of a server and a database,
wherein said data pertaining to a simulated patient comprises a patient name,
wherein said data pertaining to a simulated person further comprises a scenario identifier,
wherein said data pertaining to a simulated patient further comprises patient vital signs,
wherein said data pertaining to a simulated patient further comprises patient complaints,
wherein said data pertaining to a simulated person further comprises discoverable data about said simulated person,
wherein said data pertaining to a simulated person further comprises background data about said simulated person,
generating, via a machine learning technique, simulated communications to mimic an interaction between a welfare and safety personnel and said simulated person,
wherein said user simulates a role of said welfare and safety personnel in said interaction,
wherein said simulated communications are based upon said data pertaining to said simulated person,
wherein said simulated communications are based upon said user data of said user,
analyzing, via a machine learning technique, responses generated by said user to said simulated communications,
wherein said responses comprise text input via said user interface,
wherein said responses are necessary to access said discoverable data of said simulated person,
generating, via a machine learning technique, a quantifiable score that reflects rapport between said welfare and safety personnel and said simulated person,
wherein said score is based on said background data of said simulated person,
wherein said score is based on said user data of said user,
wherein an amount of said discoverable data is only accessible via said user responses if said interaction possesses a minimum value of said score,
adjusting, via a machine learning technique, said score higher or lower in response to actions taken by said user,
wherein said actions comprise said responses generated by said user,
wherein the conditions for adjusting said score are affected by said background data of said simulated person,
recording said interaction as training data associated with said user profile,
wherein said training data comprises said data pertaining to said simulated person,
wherein said training data comprises all of said simulated communications and all of said responses,
wherein said training data comprises all of said changes to said score.

11. The method of claim 10, wherein a computing device records a permission level of said user profile, wherein said permission level instructs said computing device as to which content said user has permission to access via said user interface.

12. The method of claim 11, further comprising the steps of:
retrieving said permission level of said user profile, and
determining to which of said content said user has access based on said permission level.

13. The method of claim 10, wherein said welfare and safety personnel are medical professionals.

14. The method of claim 13, wherein said simulated person is a simulated patient.

15. The method of claim 14, wherein said simulated communications mimic a patient in a patient-clinician interaction.

16. The method of claim 10, wherein said score is based on said background data of said simulated person, wherein said score is based on said user data of said user, wherein an amount of said discoverable data is only accessible via said user responses if said interaction possesses a minimum value of said score.

17. A non-transitory computer-readable medium coupled to a processor,
wherein said non-transitory computer-readable medium contains instructions stored thereon, which, when executed by said processor, cause said processor to perform operations comprising:
determining an identity of a user accessing a user profile via a user interface,
retrieving said user profile having user data that pertains to said identity,
retrieving data pertaining to a simulated person from one or more of a server and a database,
wherein said data pertaining to a simulated patient comprises a patient name,
wherein said data pertaining to a simulated person further comprises a scenario identifier,
wherein said data pertaining to a simulated patient further comprises patient vital signs,
wherein said data pertaining to a simulated patient further comprises patient complaints,
wherein said data pertaining to a simulated person further comprises discoverable data about said simulated person,
wherein said data pertaining to a simulated person further comprises background data about said simulated person,
generating, via a machine learning technique, simulated communications to mimic an interaction between a welfare and safety personnel and said simulated person,
wherein said user simulates a role of said welfare and safety personnel in said interaction,
wherein said simulated communications are based upon said data pertaining to said simulated person,
wherein said simulated communications are based upon said user data of said user,
analyzing, via a machine learning technique, responses generated by said user to said simulated communications,
wherein said responses comprise text input via said user interface,
wherein said responses are necessary to access said discoverable data of said simulated person,
generating, via a machine learning technique, a quantifiable score that reflects rapport between said welfare and safety personnel and said simulated person,
wherein said score is based on said background data of said simulated person,
wherein said score is based on said user data of said user,
wherein an amount of said discoverable data is only accessible via said user responses if said interaction possesses a minimum value of said score,
adjusting, via a machine learning technique, said score higher or lower in response to actions taken by said user,
wherein said actions comprise said responses generated by said user,
wherein the conditions for adjusting said score are affected by said background data of said simulated person,
recording said interaction as training data associated with said user profile,
wherein said training data comprises said data pertaining to said simulated person,
wherein said training data comprises all of said simulated communications and all of said responses,
wherein said training data comprises all of said changes to said score.

18. The non-transitory computer-readable medium of claim 17, wherein said simulated person is a simulated patient.

19. The non-transitory computer readable medium of claim 18, wherein said simulated communications mimic a patient in a patient-clinician interaction.

20. The non-transitory computer readable medium of claim 17, wherein said score is based on said background data of said simulated person, wherein said score is based on said user data of said user, wherein an amount of said discoverable data is only accessible via said user responses if said interaction possesses a minimum value of said score.
